(19) United States
(12) Patent Application Publication
(10) Pub. No.: US 2009/0225084 A1
(43) Pub. Date: Sep. 10, 2009

(54) DATA PROCESSING UNIT, DRAWING APPARATUS AND PIXEL PACKER

(76) Inventors: Shuhei KATO, Kusatsu City (JP); Koichi Usami, Kusatsu City (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/209,872

(22) Filed: Sep. 12, 2008

Related U.S. Application Data
(63) Continuation of application No. PCT/JP2005/009702, filed on May 20, 2005.

(30) Foreign Application Priority Data
May 25, 2004 (JP) 2004-154543

(51) Int. Cl. G06T 11/20; G06F 12/08; G06F 9/302

(52) U.S. Cl. 345/441; 711/118; 712/221; 712/E09.017; 711/E12.017

(57) ABSTRACT

A data processing unit for performing a high speed drawing operation of arbitrary patterns even in individual pixels is provided. It is assumed that the color mode is set to 3 bits per pixel. A pixel “N” is written to a drawing position designated by a byte address [29:3] and a bit address [2:0]. The subsequent pixel “N+1” is written immediately after the pixel “N”. The next subsequent pixel “N+2” is written immediately after the pixel “N+1” to span the adjacent bytes. Thereby, the pixel data is continuously stored within each byte and across the boundary between bytes with no space. In this case, the operation of writing pixel data, i.e., the drawing is performed not in words or bytes but in pixels. In addition to this, high speed drawing is possible by the use of a caching system.

This Application is a continuation of the U.S. National Phase of Patent Application PCT/JP2005/009702 (U.S. Ser. No. 11/569,587) filed May 20, 2005, the contents of which are herein incorporated by reference. Patent Application PCT/JP2005/009702 (U.S. Ser. No. 11/569,587) claims the benefit of Japanese Patent Application 2004-154543 filed May 25, 2004.

### TECHNICAL FIELD

The present invention relates to a data processing unit for performing a drawing process by the use of a cache system and the related art.

### BACKGROUND ART

FIG. 14 is a block diagram of a prior art pattern drawing apparatus disclosed in Japanese Patent Published Application No. Hei 8-167038 (FIG. 1, FIG. 2, FIG. 4 and FIG. 5). As shown in FIG. 14, a plurality of different patterns having predetermined sizes are stored in advance in a pattern storing area 1006 of the pattern drawing apparatus. A pattern load control unit 1003 saves the base address of the pattern data in the pattern storing area 1006 previously used for drawing, and compares this previous base address with the base address of the pattern data in the pattern storing area 1006 to be currently used for drawing, and if mismatched, it judges that the pattern data to be currently used for drawing is not available in a pattern cache memory 1002, reads the pattern data to be currently used for drawing from the pattern storing area 1006 and writes it to the pattern cache memory 1002. A drawing control unit 1001 reads the pattern data from the pattern cache memory 1002, and writes it to a drawing area 1005.

In this case, the pattern cache memory 1002 and the drawing area 1005 do not share a bus but are connected individually to separate buses. In other words, an address and data for the pattern cache memory 1002 are transmitted via a bus which is provided separately from that for the drawing area 1005. Because of this, it is possible to simultaneously read pattern data from the pattern cache memory 1002 and write pattern data to the drawing area 1005. This fact and the use of the pattern cache memory 1002 are effective to reduce the drawing time.

In addition, when a pattern is drawn with an offset in bits, the drawing control unit 1001 reads pattern data stored in adjacent two words from the pattern cache memory 1002 for preparing one-word data to be written, selects the one-word data by the use of a barrel shifter and the like, and writes it in the drawing area 1005.

However, in accordance with the above pattern drawing apparatus, the write operation to the drawing area 1005 and the pattern cache memory 1002 is performed by the word at a time. Furthermore, it is possible to write only the pattern data, which has been stored in the pattern storing area 1006 in advance, to the drawing area 1005.

In other words, it is possible to write only predetermined pattern data in words. In accordance with this system, it is impossible to draw arbitrary patterns in individual pixels.

### DISCLOSURE OF INVENTION

Accordingly, it is an object of the present invention to provide a data processing unit and the related art for performing a high speed drawing operation of arbitrary patterns even in individual pixels.

It is another object of the present invention to provide a data processing unit and the related art for setting a color mode to an arbitrary value without awareness of the number of bits forming one word of the memory which is currently used.

It is a further object of the present invention to provide a data processing unit and the related art for increasing the process speed and simplifying programming without need for calculating the bit position within a byte when drawing is performed in individual pixels.

In accordance with a first embodiment of the present invention, a data processing unit is operable to perform a write operation of pixel data which designates a display color of one pixel by M bits (M is 1 or a larger integer), and comprises: a memory operable to provide a drawing area; an arithmetic processing unit operable to perform arithmetic operations in accordance with a program; and a drawing unit operable to perform the write operation of the pixel data given from said arithmetic processing unit on a pixel-by-pixel basis in accordance with address information pointing to a drawing position generated by said arithmetic processing unit, wherein said drawing unit comprising: a cache to which a block of said memory is dynamically mapped and to which the same logical address is assigned as the block; and a cache control unit operable to write the pixel data to said cache on a pixel-by-pixel basis regardless of whether or not each of N/M and M/N is an integer where N is the number of bits per word of said memory (N is 2 or larger integer).

In accordance with this configuration, a color mode (M bits per pixel) can be set to an arbitrary value without awareness of the number of bits forming one word of the memory. Contrary to this, in general, when the configuration of bitmap images is determined, the number M of bits representing a color mode is selected in order that N/M or M/N is an integer, i.e., any one pixel is stored in order not to span two words of the memory even if M≦N, or the data of one pixel is stored and just fitted into a certain number of words of the memory even if M>N, such that the range of choice of the color mode is narrow. However, the application of the present invention is not limited to the drawing of bitmap images.

In addition, the drawing unit writes, to the cache, pixel data given from the arithmetic processing unit. Namely, unlike the prior art technique disclosed in Japanese Patent Published Application No. Hei 8-167038, the drawing unit does not directly access the memory to obtain pixel data for drawing. Since the pixel data is prepared by the arithmetic processing unit, the pattern data to be drawn may be predetermined pattern data prepared in advance, pattern data as compressed, pattern data as input by a user through an input device (such as a tablet) . In addition, since the cache is used, it is possible to perform high speed drawing. As a result, it is possible to quickly draw arbitrary patterns in individual pixels.

The data processing unit as described above further comprises a bus, wherein said memory, said arithmetic processing unit and said drawing unit are connected to said bus, and wherein said arithmetic processing unit and said drawing unit function respectively as a bus master of said bus.

In accordance with this configuration, since drawing unit can autonomously operate as a bus master, said arithmetic processing unit (such as a CPU) can process another task while the drawing unit is performing the drawing. Accordingly, an effective process can be realized when viewed as the whole of the data processing unit. Also, since the drawing process can be performed by drawing unit serving as a bus master, it is possible to lessen the burden of writing a program to be run in the arithmetic processing unit.

Generally speaking, when an arithmetic processing unit performs drawing on a memory, the drawing is performed in words as units which can be handled by the arithmetic processing unit, and therefore if the drawing is performed in bits, the arithmetic processing unit has to perform read-modify-write operations which substantially burden the arithmetic processing unit, and the programming becomes complicated. Contrary to this, in accordance with the present invention, the drawing unit functions as the bus master and can be responsible for performing read-modify-write operations while the arithmetic processing unit can perform another task, and the burden of programming can be lessened without awareness of read-modify-write operations.

In addition, the drawing unit is designed as a bus master which can share the memory with the arithmetic processing unit, and therefore a dedicated memory and a bus for drawing need not be prepared such that the cost can be reduced. Namely, if the drawing unit were not a bus master, it could not autonomously access the bus and thereby a dedicated memory and a bus for drawing must be prepared to incur an additional cost, which is not needed in accordance with this configuration.

In accordance with a second aspect of the present invention, a data processing unit is operable to perform a write operation of pixel data which designates a display color of one pixel by M bits (M is 1 or a larger integer), and comprises: a memory operable to provide a drawing area; an arithmetic processing unit operable to perform arithmetic operations in accordance with a program and generate address information pointing to a drawing position; and a drawing unit operable to perform the write operation of the pixel data given from said arithmetic processing unit on a pixel-by-pixel basis, wherein said drawing unit comprising: a cache to which a block of said memory is dynamically mapped and to which the same logical address is assigned as the block; and a cache control unit operable to write the pixel data to said cache on a pixel-by-pixel basis in accordance with the address information generated by said arithmetic processing unit, wherein the address information pointing to a drawing position contains a byte address pointing to a byte in which the first drawing bit of pixel data to be drawn is located and a bit address pointing to a bit position of the first drawing bit within the byte.

In accordance with this configuration, the arithmetic processing unit informs the drawing unit of a drawing position designated by not only a byte address but also a bit address, and therefore the arithmetic processing unit can be free from the burden of calculating the bit position within a byte from which a drawing operation is performed in individual pixels so that fast operations and simplification of programming can be realized. In usual, the address information is given as a byte address, and therefore if the number of bits of one pixel is smaller than the number of bits of one word of the memory, the calculation of the bit position within a byte must be performed when the drawing is performed for individual pixels.

In accordance with a third aspect of the present invention, a drawing device comprises: a cache to which a block of a memory providing a drawing area is dynamically mapped and to which the same logical address is assigned as the block; and a cache control unit operable to write pixel data to be drawn which designates a display color of one pixel by M bits (M is 1 or a larger integer) to said cache on a pixel-by-pixel basis in accordance with address information pointing to a drawing position regardless of whether or not each of N/M and M/N is an integer where N is the number of bits per word of the memory (N is 2 or larger integer).

In accordance with this configuration, a color mode (M bits per pixel) can be set to an arbitrary value without awareness of the number of bits forming one word of the memory. Contrary to this, in general, when the configuration of bitmap images is determined, the number M of bits representing a color mode is selected in order that N/M or M/N is an integer, i.e., any one pixel is stored in order not to span two words of the memory even if M≦N, or the data of one pixel is stored and just fitted into a certain number of words of the memory even if M>N, such that the range of choice of the color mode is narrow. However, the application of the present invention is not limited to the drawing of bitmap images.

In addition, since a cache system is used, it is possible to perform high speed drawing.

In the drawing device as described above, the address information pointing to a drawing position contains a byte address pointing to a byte in which the first drawing bit of the pixel data to be drawn is located and a bit address pointing to a bit position of the first drawing bit within the byte, and wherein said cache control unit judges whether cache hit or miss occurs on the basis of the byte address and, if cache hit occurs, updates block data as read from said cache by the pixel data to be drawn on the basis of the byte address, the bit address and the number M of bits of the pixel data, and writes the updated block data to said cache.

In accordance with this configuration, since a drawing position can be designated by not only a byte address but also a bit address, a drawing operation can be performed in individual pixels without calculating the bit position within a byte so that fast operations can be realized.

In the drawing device as described above, said cache comprises a plurality of blocks to which a plurality of blocks of the memory are mapped dynamically and respectively and to which the same logical addresses are assigned as the blocks of said memory respectively, wherein, when updating the block data, said cache control unit updates M bits, which start from the drawing position pointed to by the bit address, of the block data stored in said block designated by the byte address by the use of the pixel data to be drawn, wherein if the pixel data to be drawn is stored to span two blocks, said cache control unit updates M bits by the use of the pixel data to be drawn, which start from the drawing position, with regards to the block data stored in said block designated by the byte address and the block data stored in said block designated by the byte address which is the byte address as incremented by one.

In accordance with this configuration, since the cache provides a plurality of blocks, even if the pixel data to be drawn is stored extending across a word boundary in the memory, the drawing can easily proceed only by updating the block data stored in two blocks of the cache.

In the drawing device as described above, said cache control unit judges whether cache hit or miss occurs on the basis of a byte address (referred to hereinbelow as the read byte address) pointing to a byte in which the first reading bit of pixel data to be read is located and, if cache hit occurs, extracts the pixel data from the block data as read from said cache on the basis of the read byte address, a bit address (referred to hereinbelow as the read bit address) pointing to the bit position of the first reading bit within the byte and the number M of bits of the pixel data.

In accordance with this configuration, since a reading position can be designated by not only a byte address but also a bit address, a reading operation can be performed in individual pixels without calculating the bit position within a byte so that fast operations for reading data in individual pixels can be realized.

In the drawing device as described above, said cache comprises a plurality of blocks to which a plurality of blocks of the memory are mapped dynamically and respectively and to which the same logical addresses are assigned as the blocks of said memory respectively, wherein, when extracting the pixel data to be read, said cache control unit extracts M bits of the pixel data to be read which start from the first reading bit, wherein if the pixel data to be read is stored to span two blocks, said cache control unit extracts M bits of the pixel data to be read, which start from the first reading bit, from the block data stored in said block designated by the read byte address and the block data stored in said block designated by the byte address which is the read byte address as incremented by one.

In accordance with this configuration, since the cache provides a plurality of blocks, even if the pixel data to be read is stored extending across a word boundary in the memory, the reading operation can be easily performed only by extracting the pixel data to be drawn from the block data stored in two blocks of the cache.

In the drawing device as described above, said cache includes two blocks to which two blocks of the memory are mapped.

In accordance with this configuration, by the use of a minimum necessary construction, drawing and reading operations can be effectively performed across a word boundary.

In the drawing device as described above, the blocks of said cache comprises registers.

In accordance with this configuration, as compared with the case where the cache were composed of RAM cells, faster drawing and reading operations become possible. Also, in the case where the number of total bits forming the cache is comparatively small, the area occupied by a cache comprising registers in a semiconductor chip may be smaller than that occupied by a cache comprising RAM cells.

In the drawing device as described above, the blocks of the memory are mapped to the blocks of said cache in accordance with a direct mapping technique.

In accordance with this configuration, while making effective use of the advantage of the direct mapping technique that the circuit design is simplified, the disadvantage of the direct mapping technique that the cache hit ratio decreases when successively accessing a plurality of memory blocks mapped to the same cache block resulting in cache collision is not an issue because the drawing operation is usually performed in contiguous addresses.

In the drawing device as described above, data coherency between said memory and said cache is maintained by a write back operation, and wherein a flushing unit is provided for forcibly writing back data from said cache to said memory.

In accordance with this configuration, while making effective use of the advantage of the write back operations that the memory access is restrained, the disadvantage of the write back operations that data coherency is not always maintained can be resolved by a cache flush operation which is commanded by another unit (for example, a CPU) in order to forcibly write back data to the memory.

In the drawing device as described above, when write data is output in order to maintain data coherency, said cache control unit outputs the write data on a byte-by-byte basis or a word-by-word basis of said memory.

In accordance with this configuration, it is possible to restrain the frequency of accessing the bus as compared with the case of outputting the write data on a pixel-by-pixel basis.

In the drawing device as described above, when a memory operation is performed in an address outside of the current area of caching, said cache control unit reads data stored in this address of said memory on a byte-by-byte basis or a word-by-word basis of said memory.

In accordance with this configuration, it is possible to restrain the frequency of accessing the bus as compared with the case of reading data on a pixel-by-pixel basis.

The drawing device as described above further comprises a drawing and reading position calculating unit operable to calculate address information pointing to a next drawing or reading position on the basis of a current drawing or reading position.

In accordance with this configuration, since the address is automatically updated, it is possible to quickly perform the drawing or reading of a sequence of pixel data. In other words, it is not needed to generate an address by an external unit (for example, a CPU) for supplying the address to the drawing unit every time a pixel is drawn or read out.

In the drawing device as described above, said drawing and reading position calculating unit operable to calculate the address information pointing to the next drawing or reading position by adding the number M of bits of the pixel data to the current drawing or reading position.

In accordance with this configuration, it is possible to automatically update the address in an easy way.

The drawing device as described above is connected to a bus to which the memory is connected, and wherein the drawing device functions as a bus master of the bus.

In accordance with this configuration, since the drawing device can autonomously operate as a bus master, another processing unit (such as a CPU) can process another task while the drawing device is performing the drawing.

In addition, the drawing device is designed as a bus master which can share the memory with another processing unit (such as a CPU) , and therefore a dedicated memory and a bus for drawing need not be prepared such that the cost can be reduced. In other words, if the drawing device were not a bus master, it could not autonomously access the bus and thereby a dedicated memory and a bus for drawing must be prepared to incur an additional cost, which is not needed in this case.

In accordance with a fourth aspect of the present invention, a data processing unit comprises: an address bus through which an address space can be accessed; a data bus operable to transport data by designating an address of the address space through said address bus; a central processing unit connected to said address bus and said data bus and operable to perform operations of reading and writing data through said address bus and said data bus; and a cache system connected to said address bus and said data bus and operable to perform caching data stored in part of the address space, wherein said cache system includes control registers to which said central processing unit writes data, and functions as a bus master of said address bus and said data bus, wherein said central processing unit is capable of performing read and write operations through said address bus and said data bus without the use of said cache system, and writing data to said control registers of said cache system in order to instruct said cache system to perform read and write operations through said address bus and said data bus as a bus master, and wherein said central processing unit is capable of performing another task after instructing said cache system to perform a read or write operation through said address bus and said data bus.

In accordance with this configuration, since the cache system can autonomously operate as a bus master, the central processing unit can process another task while the cache system is performing the memory operation.

In a preferred embodiment, the data processing unit further comprises data transmission channel having a higher data transmission rate than that of said address bus and said data bus wherein writing data to said control registers of said cache system by said central processing unit is performed through the data transmission channel.

In accordance with this configuration, in the case where the cache system performs a memory operation through said address bus and said data bus (in this context, the address bus and the data bus of the second bus 33 as described below), the corresponding command can be quickly given to the cache system by said data processing unit via the higher data transmission channel (in this context, the address bus and the data bus of the first bus 31 as described below).

Furthermore, in a preferred embodiment, said address bus and said data bus are provided for communication with an external memory providing a physical storage area in the address space, and wherein the data transmission channel comprises an internal bus for communication among internal bus devices including said central processing unit.

In accordance with a fifth aspect of the present invention, a drawing device operable to plot a pixel in a drawing area comprises: a bus interface connectable to an address bus through which an address space including the drawing area can be accessed and a data bus operable to transport data by designating an address of the address space through said address bus; a data storage unit connected to said bus interface, said bus interface serving to transfer image data to said data storage unit from said data bus and output the data stored in said data storage unit to said data bus respectively by outputting an address which points to the image data in the address space to said address bus; a plot color register operable to store pixel data of a pixel to be plotted in the drawing area; a color mode register operable to store a color mode as the number of bits per pixel; a plot location counter operable to store the address pointing to the image data as a byte address and a bit position within the byte pointed to by the byte address as a bit address, wherein the byte address and the bit address point to a plot location in bits, and operable to increment the plot location after plotting the pixel data to the plot location by the number of bits corresponding to the color mode stored in said color mode register; a pixel packer connected to said plot color register, said color mode register, said plot location counter and said data storage unit, and operable to align in bits the bit position of the pixel data stored in said plot color register relative to the image data as transferred to said data storage unit with the plot location pointed to by said plot location counter, and write the pixel data to the image data as transferred to said data storage unit at the plot location on the basis of the number of bits corresponding to the color mode stored in said color mode register.

In accordance with this configuration, it becomes easy to make a program for plotting data in the drawing area in units of pixels.

In a preferred embodiment, the drawing device further comprises a pixel unpacker connected to said plot location counter and said data storage unit, and operable to receives the pixel data located in the image data transferred to said data storage unit at the plot location pointed to by said plot location counter, and output data containing this pixel data aligned at the first bit thereof.

Furthermore, in a preferred embodiment, said pixel unpacker is connected further to said color mode register, and output the data containing the pixel data zero-extended on the basis of the number of bits corresponding to the color mode stored in said color mode register.

In accordance with a sixth aspect of the present invention, a pixel packer is operable to pack a plurality of pixel data items, wherein each pixel data item contains lower bits which are pixel data bits representing a pixel value and the remaining upper bits which are unused bits, and comprises: a storage unit operable to store data having a predetermined bit length; a shifter having an output port of the predetermined bit length and operable to successively receive the pixel data item, shift the pixel data item in alignment with a first bit position, and output the pixel data item as shifted through the output port; and a data transfer unit connected to said storage unit and said shifter and operable to transfer the pixel data bits as shifted from said shifter to said storage unit, wherein the first bit position is updated after data transfer by shifting the first bit position by the length of the lower bits of the pixel data item, and wherein the pixel data bits are transferred in order not to change the storage area of said storage unit corresponding to the previous position of the first bit position where the previous pixel data bits are stored.

In accordance with this configuration, while a pixel data item can be prepared as byte data or word data, with unused upper bits if any, irrespective of the size of the pixel data bits, the pixel data bits can be packed without space so that it is easy to make a program for preparing pixel data items while the memory space occupied by pixel data bits can be minimized by the use of the pixel packer.

In a preferred embodiment, the shift operation of the first bit position is a cyclic shift operation of the predetermined bit length.

### BRIEF DESCRIPTION OF DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a block diagram showing the overall configuration of a processor in accordance with an embodiment of the present invention.

FIG. 2 is a view for explaining an exemplary operation of the pixel plotter shown in FIG. 1.

FIG. 3 is a view for explaining the input and output signals of the pixel plotter shown in FIG. 1.

FIG. 4 is a block diagram showing the internal configuration of the pixel plotter of FIG. 3.

FIG. 5 is a block diagram showing the internal configuration of the plot location counter of FIG. 4.

FIG. 6 is a block diagram showing the internal configuration of the pixel cache unit of FIG. 4.

FIG. 7A is a view showing the truth table of the dirty bit “DTY0” shown in FIG. 6.

FIG. 7B is a view showing the truth table of the dirty bit “DTY1” shown in FIG. 6.

FIG. 8A is a view showing the truth table of the valid bit control signals “VCON0” and “IVCN0” output from the valid bit control circuit shown in FIG. 6.

FIG. 8B is a view showing the truth table of the valid bit control signals “VCON1” and “IVCN1” output from the valid bit control circuit shown in FIG. 6.

FIG. 9 is an explanatory view for showing the select signals “MSL1U”, “MSL1L”, “MSL0U” and “MSL0L” generated by the multiplexer control circuit of FIG. 6.

FIG. 10 is a circuit diagram showing a circuit for generating the write request signal “WRQ0” of FIG. 6.

FIG. 11 is a circuit diagram showing a circuit for generating the read request signal “RREQ” of FIG. 6.

FIG. 12 is a circuit diagram of the pixel packer of FIG. 6.

FIG. 13 is a circuit diagram of the pixel unpacker of FIG. 6.

FIG. 14 is a block diagram of a prior art pattern drawing apparatus.

### BEST MODE FOR CARRYING OUT THE INVENTION

In what follows, an embodiment of the present invention will be explained in conjunction with the accompanying drawings. Meanwhile, like references indicate the same or functionally similar elements throughout the respective drawings, and therefore redundant explanation is not repeated. Also, when it is necessary to specify a particular bit or bits of a signal in the description or the drawings, [a] or [a:b] is suffixed to the name of the signal. While [a] stands for the a-th bit of the signal, [a:b] stands for the a-th to b-th bits of the signal. In addition, when a truth table is used for explanation, “1” stands for “true”, “0” for “false” and “X” for “don't care” or “unknown”.

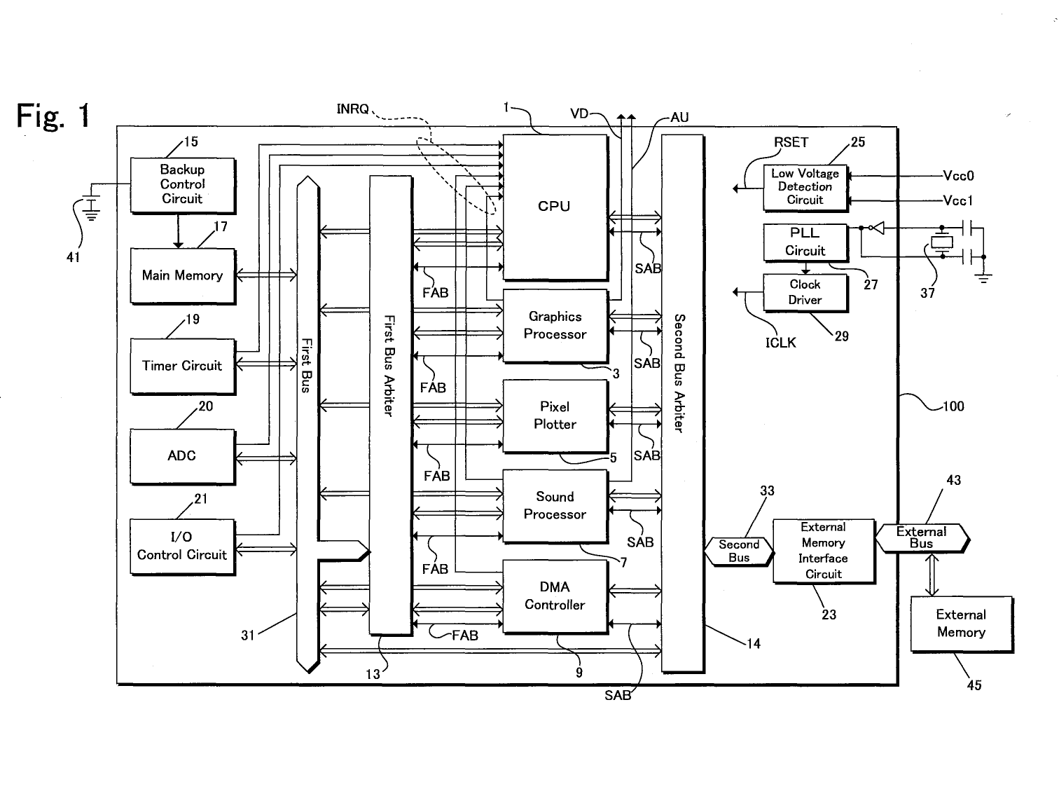

FIG. 1 is a block diagram showing the overall configuration of a processor 100 as a data processing unit in accordance with an embodiment of the present invention. As shown in FIG. 1, this processor 100 includes a central processing unit (CPU) 1, a graphics processor 3, a pixel plotter 5, a sound processor 7, a DMA (direct memory access) controller 9, a first bus arbiter 13, a second bus arbiter 14, a backup control circuit 15, a main memory 17, a timer circuit 19, an analog-to-digital converter (ADC) 20, an input/output control circuit 21, an external memory interface circuit 23, a clock driver 29, a PLL (phase-locked loop) circuit 27, a low voltage detection circuit 25, a first bus 31 and a second bus 33.

In the present embodiment, the main memory 17 and the external memory 45 are generally referred to as the “memory MEM” in the case where they need not be distinguished.

The CPU 1 performs various operations and controls the overall system in accordance with a program stored in the memory MEM. The CPU 1 is a bus master of the first bus 31 and the second bus 33, and can access the resources connected to the respective buses.

The graphics processor 3 is a bus master of the first bus 31 and the second bus 33, and serves to convert the data stored in the memory MEM into graphic data, and generate a video signal “VD” to be output to a television receiver (not shown in the figure) on the basis of the graphic data.

In this case, the graphic data is generated by combining background screen data, sprite data and bitmap screen data. The background screen which covers entirety of the screen of a television receiver comprises a two-dimensional array. And each array element comprises of rectangular sets of pixels. A sprite consists of a rectangular set of picture elements which can be relocated in any position of the screen of the television receiver. The bitmap screen data consists of a two-dimensional pixel array of which the size and location as displayed can be freely designated.

Also, the graphics processor 3 is controlled by the CPU 1 through the first bus 31, and capable of issuing an interrupt request signal “INRQ” to the CPU 1.

The pixel plotter 5, which is related to one of the characteristic features of the present invention, is controlled by the CPU 1 through the first bus 31, and capable of drawing pixel data as given from the CPU 1. In this example, the drawing operation can be performed in individual pixels. The pixel data is data representing the display color of one pixel by “M” bits (“M” is one or a larger integer corresponding to a color mode of “M” bits/pixel). In the present embodiment, M=1 to 8 as an example. Meanwhile, in the present embodiment, an indirect color representation method is employed by the use of a color palette for designating physical colors to be displayed.

Also, the pixel plotter 5 makes it possible to perform high-speed drawing and effectively use the buses (the first bus 31 and the second bus 33) by virtue of a cache system. Furthermore, the pixel plotter 5 is a bus master of the first bus 31 and the second bus 33, and capable of autonomously writing data from a cache 590 as described below to the memory MEM and from the memory MEM to the cache 590. the pixel plotter 5 will be explained in detail later.

The sound processor 7 is a bus master of the first bus 31 and the second bus 33, and serves to convert data stored in the memory MEM into sound data, and generate and output an audio signal “AU” on the basis of the sound data.

The sound data is synthesized by pitch conversion and amplitude modulation of PCM (pulse code modulation) data serving as the starting base data of tone quality. For the amplitude modulation, a function for reproducing waveforms of a music instrument is provided in addition to the volume control function performed in response to an instruction of the CPU 1.

Furthermore, the sound processor 7 is controlled by the CPU 1 through the first bus 31, and capable of issuing an interrupt request signal “INRQ” to the CPU 1.

The DMA controller 9 controls data transfer from the external memory 45 connected to an external bus 43 to the main memory 17. The external memory 45 may be implemented with, for example, an SRAM (static random access memory), a DRAM (dynamic random access memory), a ROM (read only memory) or any other appropriate memory, or implemented with a combination of any number of such memories. On the other hand, the DMA controller 9 has the function of outputting, to the CPU 1, an interrupt request signal “INRQ” indicative of the completion of the data transfer. Particularly, the DMA controller 9 is a bus master of the first bus 31 and the second bus 33, and controlled by the CPU 1 through the first bus 31.

The main memory 17 may be implemented with one or any necessary combination of a mask ROM, an SRAM and a DRAM in accordance with the system requirements. In the present embodiment, the main memory 17 is composed of an SRAM.

The backup control circuit 15 deactivates the main memory 17 when the low voltage detection circuit 25 to be described below detects a low voltage condition. On the other hand, the main memory 17 is supplied with a power supply voltage from the battery 41. Accordingly, the data stored in the main memory 17 composed of the SRAM can be maintained even after the power supply voltages Vcc0 and Vcc1 are taken away.

The first bus arbiter 13 receives first bus use request signals from the respective bus masters of the first bus 31, performs bus arbitration among the requests, and issues a first bus use acknowledge signal to one of the respective bus masters. More specifically speaking, while there are multiple sets of priority level information relating to the priority levels (priority rankings) assigned to a plurality of the bus masters in regard to the use of the first bus 31, the first bus arbiter 13 performs arbitration on the basis of one of the multiple sets of priority level information which is sequentially and cyclically selected.

Each bus master is permitted to access the first bus 31 after receiving the first bus use acknowledge signal. In this example, the first bus use request signal and the first bus use acknowledge signal are illustrated as first bus arbitration signals “FAB” in FIG. 1.

For example, the first bus 31 includes a data bus of 8 bits, an address bus of 15 bits and a control bus.

The second bus arbiter receives second bus use request signals from the respective bus masters of the second bus 33, performs bus arbitration among the requests, and issues a second bus use acknowledge signal to one of the respective bus masters. More specifically speaking, while there are multiple sets of priority level information relating to the priority levels assigned to a plurality of the bus masters in regard to the use of the second bus 33, the second bus arbiter 14 performs arbitration on the basis of one of the multiple sets of priority level information which is sequentially and cyclically selected.

Each bus master is permitted to access the second bus 33 after receiving the second bus use acknowledge signal. In this example, the second bus use request signal and the second bus use acknowledge signal are illustrated as second bus arbitration signals “SAB” in FIG. 1.

For example, the second bus 33 includes a data bus of 16 bits, an address bus of 27 bits and a control bus.

The timer circuit 19 has the function of repeatedly outputting an interrupt request signal “INRQ” to the CPU 1 with a predetermined interval. The setting of the time interval and so forth is performed by the CPU 1 through the first bus 31.

The ADC 20 converts an analog input signal to a digital signal. This digital signal is read by the CPU 1 through the first bus 31. In addition, the ADC 20 has the function of outputting an interrupt request signal “INRQ” to the CPU 1. Incidentally, an analog signal as output from an external device is input to the ADC 20, for example, through any one of six analog ports “AIN0” to “AIN5”.

The input/output control circuit 21 serves to perform the input and output operations of input and output signals to enable the communication with external input/output devices and/or external semiconductor devices. The read and write operations of input and output signals are controlled by the CPU 1 through the first bus 31. Also, the input/output control circuit 21 has the function of outputting an interrupt request signal “INRQ” to the CPU 1. Incidentally, the input and output signals are input and output, for example, through programmable input/output ports “IO0” to “IO23”.

The low voltage detection circuit 25 monitors the power supply voltages Vcc0 and Vcc1, and issues a reset signal to the PLL circuit 27 and a reset signal “RSET” to the other circuit elements of the entire system when either the power supply voltage Vcc0 or Vcc1 falls below corresponding one of reference voltages which are determined in advance individually for the respective power supply voltages Vcc0 and Vcc1.

For example, the power supply voltage Vcc0 is for example+2.5 V, which is supplied mainly to digital circuits in the processor. On the other hand, the power supply voltage Vcc1 is for example+3.3 V, which is supplied mainly to analog circuits in the processor.

The PLL circuit 27 generates a high frequency clock signal by multiplication of the sinusoidal signal as obtained from a crystal oscillator 37.

The clock driver 29 amplifies the high frequency clock signal as received from the PLL circuit 27 to a sufficient signal level to supply the respective blocks with the amplified high frequency clock signal as an internal clock signal “ICLK”.

The external memory interface circuit 23 has the function of connecting the second bus 33 to the external bus 43.

Next, the data transfer paths within the processor shown in FIG. 1 will be explained. For example, in the case where the CPU 1 controls, as a bus master, one of the other functional blocks (the graphics processor 3, the pixel plotter 5, the sound processor 7, the DMA controller 9, the first bus arbiter 13, the second bus arbiter 14 and the like) respectively connected to the first bus 31 as a bus slave, the CPU 1 outputs write data to the first bus arbiter 13 for writing the write data to the control register of the functional block and, after arbitration, the first bus arbiter 13 transmits the write data to the control register through the first bus 31, while the CPU 1 receives read data transmitted from the control register of the functional block after arbitration through the first bus 31 and the first bus arbiter 13. On the other hand, each of the graphics processor 3, the pixel plotter 5, the sound processor 7 and the DMA controller 9 has the function of outputting the first bus use request signal to the first bus arbiter 13 as a bus master of the first bus 31.

When accessing the main memory 17, a bus master outputs write data to the first bus arbiter 13 for writing the write data to the main memory 17 and the first bus arbiter 13 transmits the write data to the main memory 17 after arbitration through the first bus 31, while a bus master receives read data from the main memory 17 after arbitration through the first bus 31 and the first bus arbiter 13. Also, when accessing the external memory 45, a bus master outputs write data to the second bus arbiter 14 for writing the write data to the external memory 45 and the second bus arbiter 14 transmits the write data to the external memory 45 after arbitration through the second bus 33 , the external memory interface circuit 23 and the external bus 43, while a bus master receives the read data from the external memory 45 after arbitration through the external bus 43, the external memory interface circuit 23, the second bus 33 and the second bus arbiter 14.

In accordance with the present embodiment, the memory MEM is used to provide a drawing area. In the case where the memory MEM is shared by a plurality of bus masters, where the cache 590 is devoted to a single bus master and where write back control is employed, then cache coherency can not always be maintained. Therefore, if there is data inconsistency between the cache 590 and the memory MEM, the CPU 1 serves to flush the data in the cache 590 to the memory MEM so that cache coherency is maintained.

Next, the operation of the pixel plotter 5 will be briefly explained. In advance of drawing, the CPU 1 loads a color mode and a drawing position to the control registers of the pixel plotter 5 that is used for this purpose. In accordance with the present embodiment, as described above, there are eight color modes corresponding to one bit per pixel (2-color mode) to eight bits per pixel (256-color mode).

The drawing position is designated by a byte address and a bit address of the pixel to be drawn. In accordance with the present embodiment, for example, the drawing position is designated by a 30-bit address of which the upper 27 bits is a byte address [29:3] and the lower 3 bits is a bit address [2:0].

In other words, the byte address [29:3] is an address pointing to the byte data including the first bit of the pixel data to be drawn, and the bit address [2:0] is an address pointing to the bit position within the byte data including the first bit of the pixel data to be drawn.

The pixel data is continuously stored from a smaller byte address to a larger byte address with no space regardless of the color mode. In this case, the pixel data is continuously stored within a byte from the LSB (least significant bit) to the MSB (most significant bit) with no space regardless of the color mode. This will be explained in accordance with a specific example.

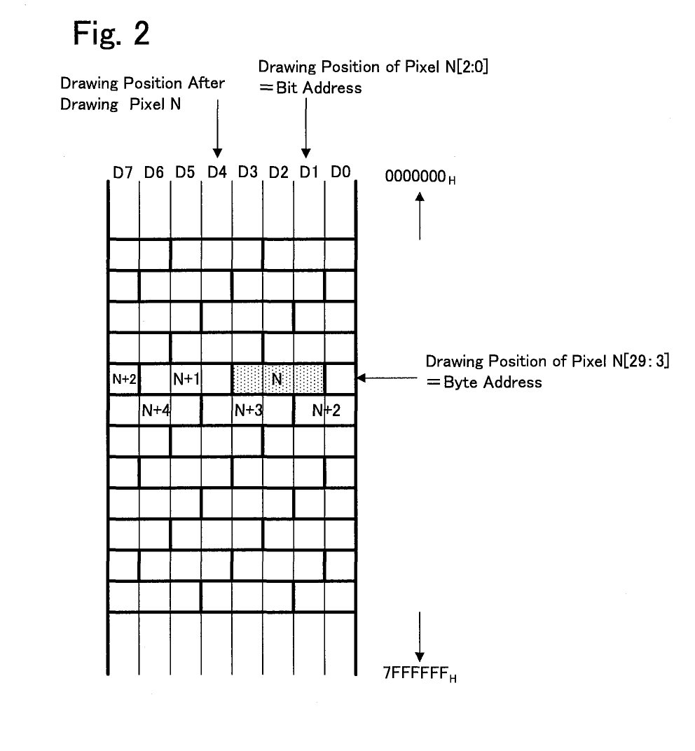

FIG. 2 is a view for explaining an exemplary operation of the pixel plotter 5 shown in FIG. 1. In FIG. 2, it is assumed that the color mode is 3 bits per pixel. As shown in FIG. 2, the pixel “N” is written to a drawing position designated by a byte address [29:3] and a bit address [2:0]. The subsequent pixel “N+1” is written immediately after the pixel “N”. The next subsequent pixel “N+2” is written immediately after the pixel “N+1” to span the adjacent bytes. In this manner, the pixel data is continuously stored within each byte and across the boundary between bytes with no space. On the other hand, in this case, the operation of writing pixel data to the cache 590, i.e., the drawing is performed not in words or bytes but in individual pixels.

Next, the pixel plotter 5 will be explained in detail.

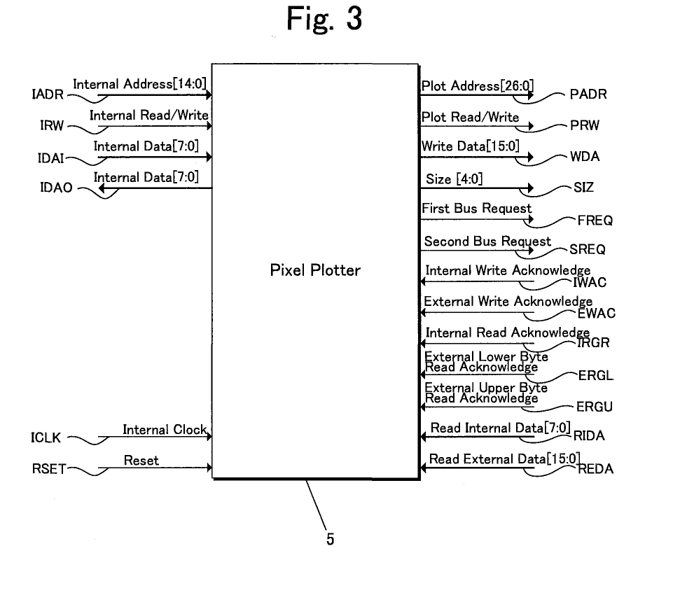

FIG. 3 is a view for explaining the input and output signals of the pixel plotter 5 shown in FIG. 1. As illustrated in FIG. 3, an internal address “IADR” is a signal, for example, a 15-bit signal in the case of the present embodiment, indicative of an address of the first bus 31 pointing to a control register of the respective functional blocks or a location of a memory. Namely, the bus width of the address bus of the first bus 31 is 15 bits. This internal address “IADR” is given to the first bus 31 through the first bus arbiter 13 from a bus master. When the CPU 1 controls the pixel plotter 5, the CPU 1 functions as a bus master and outputs the internal address “IADR” to the pixel plotter 5 through the first bus arbiter 13 and the first bus 31.

The first bus 31 provides the addresses assigned respectively to the CPU 1 (control registers), the sound processor 7 (a local memory and control registers), the graphics processor 3 (control registers, a pallet memory, and a sprite memory), the main memory 17, the pixel plotter 5 (control registers) and the like. On the other hand, the second bus 33 provides the addresses assigned respectively to the external memory 45 and the like.

An internal read/write signal “IRW” is a signal which is output from the CPU 1 through the first bus arbiter 13 and the first bus 31, and indicative of the type of access for accessing the control registers and the like in the pixel plotter 5. For example, the internal read/write signal “IRW” is output as a high level signal for reading data and a low level signal for writing data.

An internal data “IDAI” is data which is given to the pixel plotter 5 from the CPU 1 as a bus master through the first bus arbiter 13 and the first bus 31.

An internal data “IDAO” is data which is given from the pixel plotter 5 to the CPU 1 as a bus master through the first bus 31 and the first bus arbiter 13.

In accordance with the present embodiment, each of the internal data “IDAI” and “IDAO” is for example 8-bit data. In other words, the bus width of the data bus of the first bus 31 is 8 bits.

For example, the internal clock signal “ICLK” is a clock signal of about 43 MHz which is supplied from the clock driver 29. All the logic circuits of the pixel plotter 5 operates in synchronization with the internal clock signal “ICLK”. The internal clock signal “ICLK” is input to all registers to be synchronized which are located in the pixel plotter 5 but not shown in the figure.

The reset signal “RSET” is a signal for resetting all the logic circuits of the pixel plotter 5 and is output when a reset button (not shown in the figure) is pressed or the low voltage detection circuit 25 detects an undervoltage condition. Control registers having an initial state in the pixel plotter 5 are initialized again by this reset signal “RSET”.

A plot address “PADR” is a byte address pointing to the location in which is stored byte data to be read/written when the pixel plotter 5 accesses the memory MEM. The plot address “PADR” is output to the first bus 31 or the second bus 33 through the first bus arbiter 13 or the second bus arbiter 14, and then given to the memory MEM. In accordance with the present embodiment, for example, the plot address “PADR” is a 27-bit signal. When accessing the first bus 31, the lower 15 bits of the plot address “PADR” is effective.

A plot read/write signal “PRW” is a signal indicative of the type of access for accessing the memory MEM by the pixel plotter 5. For example, the plot read/write signal “PRW” is output as a high level signal for reading data and a low level signal for writing data. The plot read/write signal “PRW” is output to the first bus 31 or the second bus 33 through the first bus arbiter 13 or the second bus arbiter 14, and then given to the memory MEM.

A write data “WDA” is data to be written to the memory MEM by the pixel plotter 5. In accordance with the present embodiment, the bus width of the data bus of the first bus 31 is 8 bits and therefore the size of the write data “WDA” is one byte when writing it to the main memory 17, while the bus width of the data bus of the second bus 33 is 16 bits and therefore the size of the write data “WDA” is one byte or two bytes when writing it to the external memory 45. The write data “WDA” is output to the first bus 31 or the second bus 33 through the first bus arbiter 13 or the second bus arbiter 14, and then given to the memory MEM.

A size signal “SIZ” is output from the pixel plotter 5 as a signal indicative of the size of data to be read from or written to the memory MEM. In accordance with the present embodiment, for example, the size signal “SIZ” is a 5-bit signal. For example, if the size is one byte, the size signal “SIZ” is “00001”, while it is “00010” if the size is two bytes. The size signal “SIZ” is given to the first bus arbiter 13 and the second bus arbiter 14.

A first bus use request signal “FREQ” is a signal indicative of a bus use request for the first bus 31 and output to the first bus arbiter 13. When the first bus use request signal “FREQ” is asserted and the plot read/write signal “PRW” indicates a read operation, it means that a read request to the main memory 17 is issued. On the other hand, when the first bus use request signal “FREQ” is asserted and the plot read/write signal “PRW” indicates a write operation, it means that a write request to the main memory 17 is issued.

A second bus use request signal “SREQ” is a signal indicative of a bus use request for the second bus 33 and output to the second bus arbiter 14. When the second bus use request signal “SREQ” is asserted and the plot read/write signal “PRW” indicates a read operation, it means that a read request to the external memory 45 is issued. On the other hand, when the second bus use request signal “SREQ” is asserted and the plot read/write signal “PRW” indicates a write operation, it means that a write request to the external memory 45 is issued.

An internal write acknowledge signal “IWAC” is a signal indicating that a bus use request for writing data through the first bus 31 is accepted, and output from the first bus arbiter 13.

An external write acknowledge signal “EWAC” is a signal indicating that a bus use request for writing data through the second bus 33 is accepted, and output from the second bus arbiter 14.

An internal read acknowledge signal “IRGR” is a signal indicating that a bus use request for reading data through the first bus 31 is accepted and that data can be read from the main memory 17, and output from the first bus arbiter 13.

An external lower byte read acknowledge signal “ERGL” is a signal indicating that data can be read from the external memory 45 as the lower byte of read external data “REDA”, and output from the second bus arbiter 14.

An external upper byte read acknowledge signal “ERGU” is a signal indicating that data can be read from the external memory 45 as the upper byte of read external data “REDA”, and output from the second bus arbiter 14.

Incidentally, the first bus use request signal “FREQ”, the internal write acknowledge signal “IWAC” and the internal read acknowledge signal “IRGR” are illustrated as the first bus arbitration signals “FAB” in FIG. 1. Also, the second bus use request signal “SREQ”, the external write acknowledge signal “EWAC”, the external lower byte read acknowledge signal “ERGL” and the external upper byte read acknowledge signal “ERGU” are illustrated as the second bus arbitration signals “SAB” in FIG. 1.

A read internal data “RIDA” is output from the main memory 17 through the first bus 31 to the first bus arbiter 13, and given to the pixel plotter 5 from the first bus arbiter 13. However, since the read internal data “RIDA” may be the read data of another bus master, the pixel plotter 5 can obtain a necessary value by fetching the read internal data “RIDA” when the internal read acknowledge signal “IRGR” is asserted.

A read external data “REDA” is output from the external memory 45 to the second bus arbiter 14 through the second bus 33, and then given to the pixel plotter 5 from the second bus arbiter 14. However, the read external data “REDA” may be the read data of another bus master, the pixel plotter 5 can obtain a necessary value by fetching the lower byte of the read external data “REDA” when the external lower byte read acknowledge signal “ERGL” is asserted and fetching the upper byte of the read external data “REDA” when the external upper byte read acknowledge signal “ERGU” is asserted.

FIG. 4 is a block diagram showing the internal configuration of the pixel plotter 5 of FIG. 3. As shown in FIG. 4, the pixel plotter 5 includes an address decoder 51, a plot active register 52, a cache flush register 53, a plot bit register 54, a plot location counter 55, a plot color register 56, a multiplexer 57, a pixel cache unit 58 and a bus arbiter interface 59.

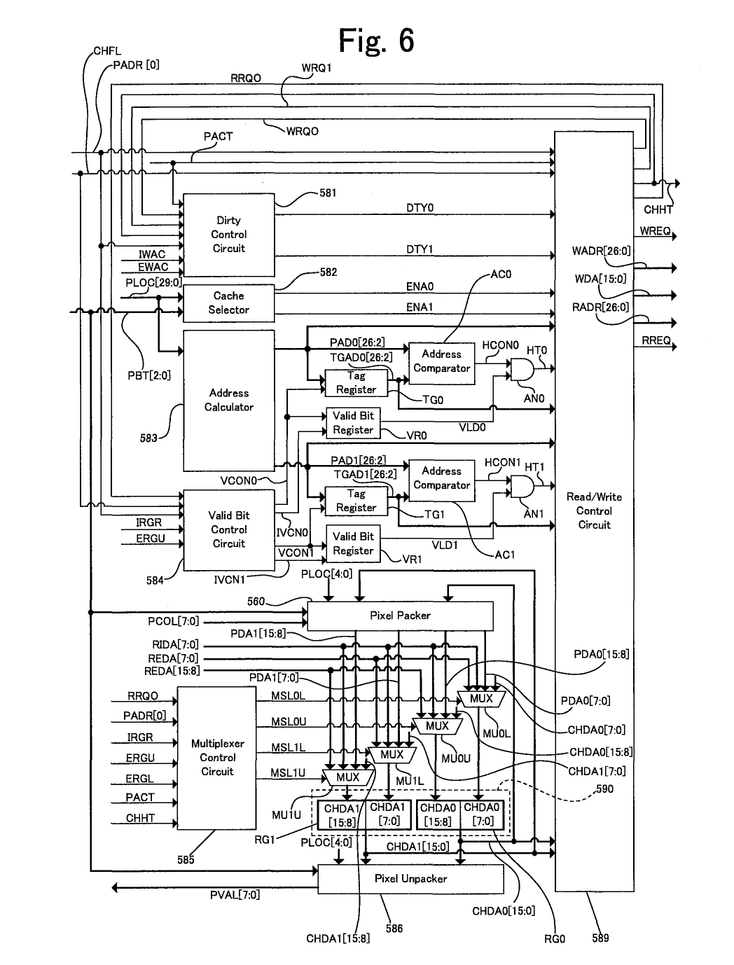

The pixel cache unit 58 includes a direct mapped cache 590 (refer to FIG. 6 to be described below) and the peripheral circuit thereof. The cache 590 includes two storage blocks RG0 and RG1 (referred to hereinbelow as “cache blocks” in the case of the present embodiment) to which two storage blocks (referred to hereinbelow as “memory blocks” in the case of the present embodiment) of the memory MEM are dynamically mapped, and each of the cache blocks and memory blocks consists of 16 bits in accordance with the present embodiment. In other words, the cache 590 comprises two 16-bit entries. This will be described below in detail.

The address decoder 51 decodes the internal address “IADR” as output from the CPU 1, and outputs a select signal for selecting one of the respective control registers 52, 53, 54 and 56, the multiplexer 57 and the counter 55. In this way, the CPU 1 can control the respective control registers 52, 53, 54 and 56 and the counter 55, and read the current value of any one of the respective control registers 52, 53, 54 and 56 and the counter 55 through the multiplexer 57.

The plot active register 52 saves a plot active bit “PACT”. The plot active bit “PACT” is a flag indicative of whether or not the drawing process is proceeding, such that if it is “true” the drawing process is proceeding, otherwise the drawing process is not proceeding. The plot active bit “PACT” is given to the pixel cache unit 58 and the plot location counter 55.

If the internal address “IADR” as decoded by the address decoder 51 points to the plot color register 56 and if the internal read/write signal “IRW” indicates a write operation, then the plot active bit “PACT” is set to “true”, and if the pixel cache unit 58 outputs a cache hit signal “CHHT” set to “true”, then the plot active bit “PACT” is set to “false”.

That is, when the drawing target data “PCOL” to be drawn is set in the plot color register 56, the plot active bit “PACT” is set to “true”. Incidentally, in this description, the term “drawing target data” is used to represent data to be stored in the cache while the “drawing cached data” to be described below is data which is already stored in the cache.

In other words, the cache hit signal “CHHT” set to “true” means that the drawing process in the cache 590 is completed and, in this case, the plot active bit “PACT” is set to “false”.

The cache flush register 53 saves a cache flush bit “CHFL”. When the cache flush bit “CHFL” is “true”, all the data stored in the cache 590 of the pixel cache unit 58 is written back to the memory MEM. The cache flush bit “CHFL” is given to the pixel cache unit 58.

If the internal address “IADR” as decoded by the address decoder 51 points to the cache flush register 53 and if the internal read/write signal “IRW” indicates a write operation, the cache flush bit “CHFL” is set to “true”. On the other hand, if both dirty bits “DTY0” and “DTY1” are “false”, the cache flush bit “CHFL” is set to “false”.

Hereinbelow, why the cache flush bit “CHFL” is provided will be briefly explained. When the operation of drawing (writing) to or reading from the memory MEM is to be performed beyond the caching area, all the data stored in the cache 590 is written back to the memory MEM. Accordingly, just after the drawing process is halt or completed, there is data lingering in the cache 590 so that coherency is not maintained with the memory MEM. In order to avoid such a situation, the CPU 1 controls the cache flush bit “CHFL” to be “true” to write back all the data in the cache 590 to the memory MEM.

The dirty bit “DTY0” indicates whether or not coherency is maintained between the data stored in the cache block RG0 and the data stored in the memory MEM. If coherency is not maintained, the dirty bit “DTY0” indicates “true”.

The dirty bit “DTY1” indicates whether or not coherency is maintained between the data stored in the cache block RG1 and the data stored in the memory MEM. If coherency is not maintained, the dirty bit “DTY1” indicates “true”.

The plot bit register 54 saves plot bits “PBT”. The plot bits “PBT” are bits to designate the color mode for drawing process. As has been discussed above, the color mode indicates the number of bits per pixel (M bits/pixel) for representing a display color. For example, the number “M” is any number of 1 to 8 so that the plot bits “PBT” consist of three bits. In this case, the numbers 0 to 7 of the plot bits “PBT” correspond respectively to 1 to 8 bits/pixel. The plot bits “PBT” are given to the pixel cache unit 58, the plot location counter 55 and the multiplexer 57.

If the internal address “IADR” is pointing to the plot bit register 54 and if the internal read/write signal “IRW” indicates a write operation, the address decoder 51 outputs a select signal to the plot bit register 54. In response to this select signal, the plot bit register 54 saves the internal data “IDAI” as color mode information.

The plot location counter 55 generates a pixel address “PLOC” pointing to the pixel position from which a drawing (writing) operation or a reading operation is performed. The pixel address “PLOC” consists of a 27-bit byte address (“PLOC[29:3]”) and a 3-bit bit address (“PLOC[2:0]”). Furthermore, the byte address “PLOC[29:3]” consists of the upper 25 bits (“PLOC[29:5]”) serving as a tag field of the cache 590 and the lower two bits (“PLOC[4:3]”) serving as an index field of the cache 590.

The index field “PLOC[4]” is used to select either of the cache blocks RG0 and RG1. The tag field “PLOC[29:5]” is compared with the tag addresses “TGAD0” and “TGAD1” to be described below. This will be explained in detail later.

The pixel address “PLOC” as described above is given to the pixel cache unit 58 and the multiplexer 57. The plot location counter 55 will be explained in detail later.

The plot color register 56 is a register for storing the drawing target data “PCOL” in order that the data is arranged from LSB with no space in accordance with the color mode. However, the drawing target data “PCOL” consists only of pixel data for one pixel. In other words, the drawing target data “PCOL” does not include pixel data for two or more pixels. As thus described, the drawing target data “PCOL” is set individually for each pixel. In accordance with the present embodiment, for example, it is assumed that the plot color register 56 is an 8-bit register. In this case, if the color mode is for example 3 bits per pixel, the drawing target data “PCOL” consists of lower three bits as pixel data and the remaining upper five bits set to “0”. The drawing target data “PCOL” is output to the pixel cache unit 58 and the multiplexer 57.

If the internal address “IADR” is pointing to the plot color register 56 and if the internal read/write signal “IRW” indicates a write operation, the address decoder 51 outputs a select signal to the plot color register 56. In response to this select signal, the plot color register 56 saves the internal data “IDAI” as the drawing target data “PCOL”.

The multiplexer 57 selects, in accordance with the select signal output from the address decoder 51, one of the plot bits “PBT”, the pixel address “PLOC”, the drawing target data “PCOL” and the drawing cached data “PVAL”, and outputs the selected data as the internal data “IDAO”.

When the internal read/write signal “IRW” indicates a read operation, the address decoder 51 outputs to the multiplexer 57 a select signal for selecting one of the plot bits “PBT”, the pixel address “PLOC”, the drawing target data “PCOL” and the drawing cached data “PVAL” in accordance with the result of decoding the internal address “IADR”. In this case, the 30 bits of the pixel address “PLOC” are divided in units of 8-bit data for selection. This is because the bus width of the first bus 31 is 8 bits in the case of this example.

The drawing cached data “PVAL” is the pixel data which is being drawn (current data in the cache 590) and arranged from LSB with no space in accordance with the color mode. However, the drawing cached data “PVAL” consists only of pixel data for one pixel. Namely, the drawing cached data “PVAL” does not include pixel data for two or more pixels. Accordingly, the CPU 1 can read pixel data individually for each pixel.

Incidentally, the drawing target data “PCOL” is data which is being loaded in the plot color register 56 (i.e., the data to be drawn next).

The bus arbiter interface 59 generates the plot address “PADR”, the plot read/write signal “PRW”, the size signal “SIZ”, the first bus use request signal “FREQ” and the second bus use request signal “SREQ”. The details are as follows.

When the read request signal “RREQ” given from the pixel cache unit 58 is asserted, the bus arbiter interface 59 outputs the read address (byte address) RADR given from the pixel cache unit 58 as the plot address “PADR”.

On the other hand, when the write request signal “WREQ” given from the pixel cache unit 58 is asserted, the bus arbiter interface 59 outputs the write address (byte address) WADR given from the pixel cache unit 58 as the plot address “PADR”.

The LSB of the plot address “PADR” is output also to the pixel cache unit 58. The LSB of the plot address “PADR” points to either of the upper 8 bits or the lower 8 bits of the cache block RG0 or RG1. In other words, the LSB of the plot address “PADR” can take a value of “0” to point to the lower 8 bits and a value of “1” to point to the upper 8 bits.

Also, when the read request signal “RREQ” is asserted, the bus arbiter interface 59 decodes the read address “RADR”, determines which of the address areas of the first bus 31 and the second bus 33 is requested, and controls the first bus use request signal “FREQ” and the second bus use request signal “SREQ” for assertion/negation.

On the other hand, when the write request signal “WREQ” is asserted, the bus arbiter interface 59 decodes the write address “WADR”, determines which of the address areas of the first bus 31 and the second bus 33 is requested, and controls the first bus use request signal “FREQ” and the second bus use request signal “SREQ” for assertion/negation.

Furthermore, the bus arbiter interface 59 outputs the size signal “SIZ” that indicates the size is 2 bytes. However, when the LSB of the read address “RADR” is “1” with the read request signal “RREQ” being asserted or when the LSB of the write address “WADR” is “1” with the write request signal “WREQ” being asserted, the size signal “SIZ” is set to a value that indicates “1 byte” for starting the access to the memory from such an address. This is because it is useless to read/write the lower byte in such a case.

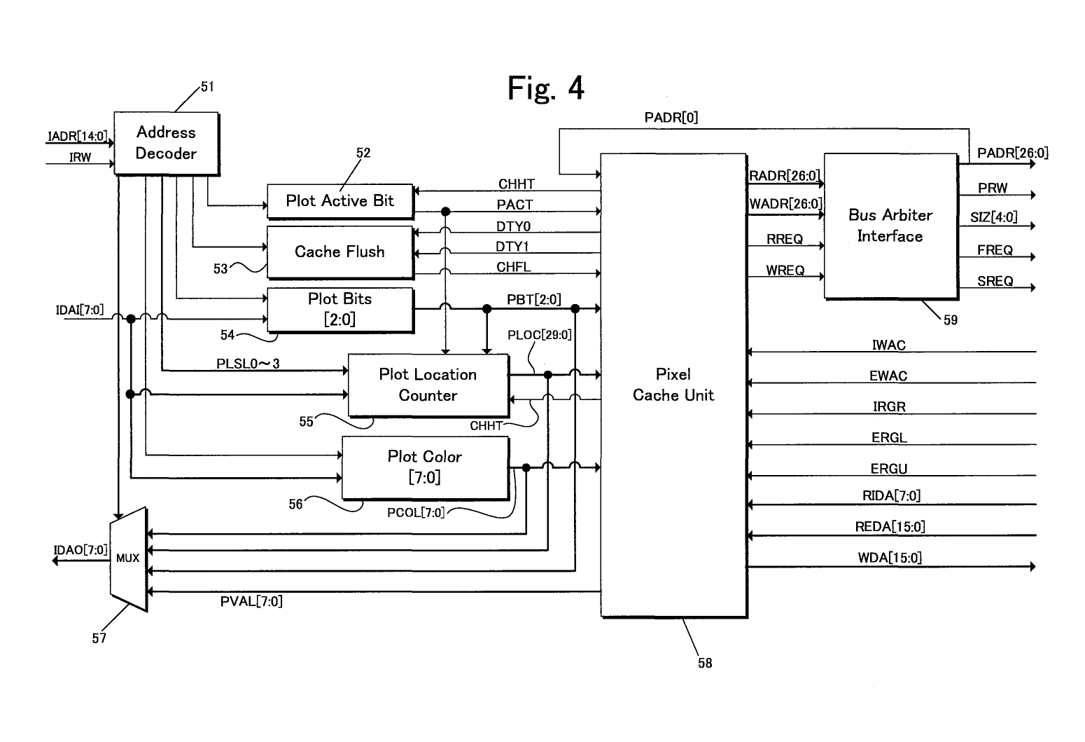

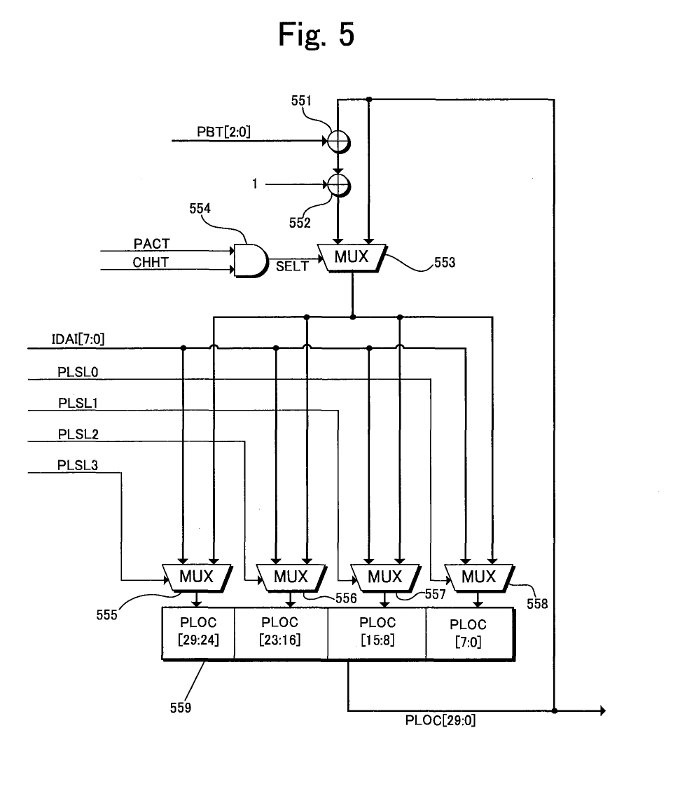

FIG. 5 is a block diagram showing the internal configuration of the plot location counter 55 of FIG. 4. As shown in FIG. 5, the plot location counter 55 includes adders 551 and 552, a multiplexer 553, an AND gate 554, multiplexers 555 to 558 and an address register 559.

The address register 559 is used to save a 30-bit pixel address “PLOC”. The CPU 1 can access this address register 559 individually for the respective bytes thereof. More specific description is as follows.

If the internal address “IADR” output from the CPU 1 indicates the pixel address “PLOC[29:24]” and if the internal read/write signal “IRW” indicates a write operation, then the address decoder 51 asserts the select signal “PLSL3”. Then, the multiplexer 555 outputs the pixel address “PLOC[29:24]” given from the CPU 1 as the internal data “IDAI” to the corresponding location of the address register 559. In like manner, the respective multiplexers 556 to 558 serve to output the corresponding pixel addresses “PLOC[23:16]” to “PLOC[7:0]” to the corresponding locations of the address register 559, in accordance with the corresponding select signals “PLSL2” to “PLSL0”.

On the other hand, when the drawing process is proceeding, the pixel address “PLOC” is incremented by the value of the color mode (M bits/pixel) indicated by the plot bits “PBT” every time the operation of drawing (writing) to or reading from the cache 590 is performed, so that the pixel address “PLOC” is updated to indicate the next drawing/reading position. More specific description is as follows.

The pixel address “PLOC” output from the address register 559 is given to one input terminal of the multiplexer 553 and also to the adder 551. This adder 551 serves to add the plot bits “PBT” output from the plot bit register 54 to the pixel address “PLOC”, and output the result of addition to the adder 552. This is because a drawing/reading operation is performed individually for each pixel so that the next drawing/reading bit position is advanced by the number of bits corresponding to one pixel data from the first drawing/reading bit position of the pixel data for current drawing/reading. For example, in the case where the color mode indicated by the plot bits “PBT” is 3 bits per pixel, the next drawing/reading bit position is advanced by 3 bits from the first drawing/reading bit position of the pixel data for current drawing/reading (refer to FIG. 2).

Accordingly, the adder 552 further adds “1” to the result of addition performed by the adder 551, and gives the result of addition to the other input terminal of the multiplexer 553. The result of addition performed by the adder 552 indicates the pixel address “PLOC” pointing to the next drawing/reading bit position. That is, if the plot bits “PBT” indicates “j” (j is an integer), the color mode is (j+1) bits per pixel. For example, if the plot bits “PBT” indicates “0”, the color mode is one bit per pixel.

By the way, in accordance with the select signal “SELT” as output from the AND gate 554, the multiplexer 553 selects either the new pixel address “PLOC” output from the adder 552 or the pixel address “PLOC” directly output from the address register 559, and outputs the selected address to the multiplexers 555 to 558. In this case, the pixel addresses “PLOC[29:24]” to “PLOC[7:0]” are output respectively to the corresponding multiplexers 555 to 558.

The AND gate 554 receives the plot active bit “PACT” and the cache hit signal “CHHT”. The cache hit signal “CHHT” is a signal which is asserted when a cache hit occurs in the cache 590 for a drawing/reading operation of the memory MEM. The select signal “SELT” is asserted when both the plot active bit “PACT” and the cache hit signal “CHHT” are asserted. Namely, if a cache hit occurs in the cache 590 while the drawing process is proceeding, the select signal “SELT” is asserted.

Accordingly, if a cache hit occurs in the cache 590 while the drawing process is proceeding, then the multiplexer 553 outputs the new pixel address “PLOC” output from the adder 552 to the multiplexers 555 to 558, otherwise the multiplexer 553 outputs the pixel address “PLOC” directly output from the address register 559 to the multiplexers 555 to 558.

Then, each of the multiplexers 555 to 558 outputs the corresponding pixel address “PLOC[29:24]” to “PLOC[7:0]”, as output from the multiplexer 553, to the corresponding location of the address register 559 when the corresponding select signal “PLSL0” to “PLSL3” is negated.

As has been discussed above, when the drawing process is proceeding, the plot location counter 55 increments the pixel address “PLOC” by the value of the color mode (M bits/pixel) indicated by the plot bits “PBT” every time the operation of drawing to or reading from the cache 590 is performed, so that the pixel address “PLOC” is updated to indicate the next drawing/reading bit position.

FIG. 6 is a block diagram showing the internal configuration of the pixel cache unit 58 of FIG. 4. As shown in FIG. 6, a pixel cache unit 58 includes a dirty control circuit 581, a cache selector 582, an address calculator 583, a valid bit control circuit 584, a multiplexer control circuit 585, multiplexers MU0L, MU0U, MU1L and MU1U, a pixel packer 560, a pixel unpacker 586, a cache 590, address comparators AC0 and AC1, tag registers TG0 and TG1, valid bit registers VR0 and VR1, AND gates AN0 and AN1 and a read/write control circuit 589.

The cache 590 includes the cache blocks RG0 and RG1. Each of the cache blocks RG0 and RG1 is composed of registers.

As has been discussed above, two memory blocks (two blocks in the memory MEM) are dynamically mapped to the two cache blocks RG0 and RG1 in the direct mapping technique. On the other hand, cache coherency between the memory MEM and the cache 590 (i.e., updating the memory MEM) is maintained by a write back system. Meanwhile, in accordance with the present embodiment, each of the cache blocks RG0 and RG1 comprises 16 bits (two 16-bit entries in total).

At first, the respective signals will be briefly explained. However, no redundant description is repeated for signals already explained. A write request signal “WRQ0” is a signal which is set to “true” when the data of the cache block RG0 is written back to the memory MEM. A write request signal “WRQ1” is a signal which is set to “true” when the data of the cache block RG1 is written back to the memory MEM.

A read request signal “RRQ0” is a signal which is set to “true” when data is read from the memory MEM and written to the cache block RG0 after the pixel address “PLOC” is set to an address outside the caching area. Also, not illustrated in the figure, a read request signal “RRQ1” is a signal which is set to “true” when data is read from the memory MEM and written to the cache block RG1 after the pixel address “PLOC” is set to an address outside the caching area.

An enable bit “ENA0” is a bit which is set to “true” when the cache block RG0 includes a part or all of the bits of the pixel data that is pointed to by the pixel address “PLOC” currently output from the plot location counter 55. An enable bit “ENA1” is a bit which is set to “true” when the cache block RG1 includes a part or all of the bits of the pixel data that is pointed to by the pixel address “PLOC” currently output from the plot location counter 55.

Accordingly, both the enable bits “ENA0” and “ENA1” are set to “true” when the pixel data that is pointed to by the pixel address “PLOC” currently output from the plot location counter 55 is stored to span the cache blocks RG0 and RG1.

A byte address “PAD0[26:2]” serves as the tag field “PLOC[29:5]” when the cache block RG0 is designated by the index field “PLOC[4:3]” of the pixel address “PLOC[29:0]” currently output from the plot location counter 55. A byte address “PAD1[26:2]” serves as the tag field “PLOC[29:5]” when the cache block RG1 is designated by the index field “PLOC[4:3]” of the pixel address “PLOC[29:0]” currently output from the plot location counter 55.

A valid bit control signal “VCON0” is a signal for controlling the tag register TG0 and the valid bit register VR0. A valid bit control signal “VCON1” is a signal for controlling the tag register TG1 and the valid bit register VR1.

A tag address “TGAD0[26:2]” is composed of the upper 25 bits of the 27-bit byte address of the memory block which is currently mapped to the cache block RG0. A tag address “TGAD1[26:2]” is composed of the upper 25 bits of the 27-bit byte address of the memory block which is currently mapped to the cache block RG1.

A bit control signal “HCON0” is a signal which is set to “true” when the byte address “PAD0[26:2]” matches the tag address “TGAD0[26:2]”. A hit control signal “HCON1” is a signal which is set to “true” when the byte address “PAD1[26:2]” matches the tag address “TGAD1[26:2]”.

A valid bit “VLD0” is a signal which indicates whether the data in the cache block RG0 is valid or invalid, and takes “true” when the data is valid and “false” when the data is invalid. A valid bit “VLD1” is a signal which indicates whether the data in the cache block RG1 is valid or invalid, and takes “true” when the data is valid and “false” when the data is invalid.

A cache hit signal “HT0” is a signal which is set to “true” if a cache hit occurs in the cache block RG0 when the operation of drawing (writing) to or reading from the memory MEM is performed. A cache hit signal “HT1” is a signal which is set to “true” if a cache hit occurs in the cache block RG1 when the operation of drawing (writing) to or reading from the memory MEM is performed.

Select signals “MSL0L”, “MSL0U”, “MSL1L” and “MSL1U” are signals which control the multiplexer “MU0L”, “MU0U”, “MU1L” and “MU1U” respectively.

Next, the respective functional blocks will be explained. The dirty control circuit 581 controls the dirty bits “DTY0” and “DTY1”. This point will be explained in detail with reference to drawings.

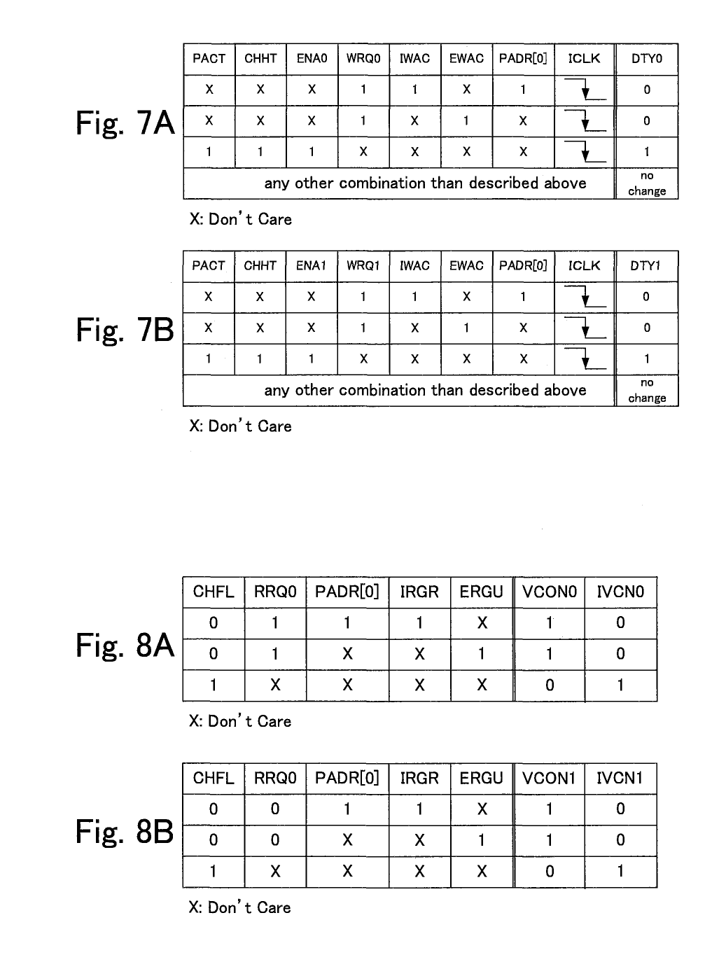

FIG. 7A is a view showing the truth table of the dirty bit “DTY0” shown in FIG. 6 and FIG. 7B is a view showing the truth table of the dirty bit “DTY1” shown in FIG. 6. As illustrated in FIG. 7A, the dirty control circuit 581 sets the dirty bit “DTY0” to “false” (with which coherency is maintained between the cache 590 and the memory MEM) at the next falling edge of the internal clock signal “ICLK” if the write request signal “WRQ0” is “true”, if the internal write acknowledge signal “IWAC” is “true” and if the LSB of the pixel address “PADR” is “1”.

In this case, the plot address “PADR[26:0]” is a byte address of which the LSB (the plot address “PADR[0]”) designates either upper or lower byte of the corresponding one of the cache blocks RG0 and RG1. In accordance with the present embodiment, the lower byte is designated if the plot address “PADR[0]” is “0” while the upper byte is designated if the plot address “PADR[0]” is “1”. Since the write back operation is performed in the blocks of the cache 590, with regard to the write back operations to the memory 17 connected to the first bus 31, the plot address “PADR[0]” being output as “1” is one of the conditions under which the dirty bit “DTY0” is set to “false”.

Also, the dirty control circuit 581 sets the dirty bit “DTY0” to “false” (with which coherency is maintained between the cache 590 and the memory MEM) at the next falling edge of the internal clock signal “ICLK” if the write request signal “WRQ0” is “true” and if the external write acknowledge signal “EWAC” is “true”.

In this case, with regard to the write back operation to the memory 45 connected to the second bus 33 through the external bus 43 and the external memory interface circuit 23, the state of the plot address “PADR[0]” is not included in the conditions of setting the dirty bit “DTY0” to “false” because a write request for simultaneously writing two bytes is issued if the plot address “PADR[0]” is “0” and a write request for writing only one byte is issued if the plot address “PADR[0]” is “1”.

On the other hand, if the plot active bit “PACT” is “true”, if the cache hit signal “CHHT” is “true”, and if the enable bit “ENA0” is “true”, then the dirty control circuit 581 sets the dirty bit “DTY0” to “true” (indicating that coherency is not maintained between the cache 590 and the memory MEM).

This is because, in this case, it means that a write operation to the cache block RG0 is performed, and then the coherency between the cache 590 and the memory MEM is not maintained.

In like manner, the dirty control circuit 581 controls the dirty bit “DTY1” in accordance with the truth table shown in FIG. 7B.

Returning to FIG. 6, the cache selector 582 controls the enable bit “ENA0” and “ENA1”. The details are as follows.

The cache selector 582 determines which the cache block RG0 or RG1 includes the first bit of the drawing (writing) or reading operation on the basis of the pixel address “PLOC”, and set to “true” the enable bit “ENA0” or “ENA1” corresponding to the cache block RG0 or RG1 in which the first bit is included.

Furthermore, the cache selector 582 determines the last bit position of the drawing or reading operation on the basis of the pixel address “PLOC” and the plot bits “PBT”, and set to “true” the enable bit “ENA0” or “ENA1” corresponding to the cache block RG0 or RG1 in which the last bit is included. This process is performed to deal with the case where the pixel data to be drawn or read is stored to span the cache blocks RG0 and RG1. Accordingly, both the enable bits “ENA0” and “ENA1” are set to “true” when the pixel data that is pointed to by the pixel address “PLOC” currently output from the plot location counter 55 are stored to span the cache blocks RG0 and RG1.

On the other hand, the cache selector 582 sets to “false” the enable bit “ENA0” and/or “ENA1” corresponding to the block RG0 and/or RG1 in which neither of the first and last bits of the drawing or reading operation is located.

The address calculator 583 generates either the byte addresses “PAD0” or “PAD1” on the basis of the pixel address “PLOC” currently output from the plot location counter 55. The details are as follows.

When the index field “PLOC[4:3]” of the pixel address “PLOC[29:0]” currently output from the plot location counter 55 designates the cache block RG0, i.e., when the index field “PLOC[4]” is “0”, the address calculator 583 outputs the current tag field “PLOC[29:5]” to the read/write control circuit 589, the address comparator AC0 and the tag register TG0 as the byte address “PAD0[26:2]”, and outputs the tag field “PLOC[29:5]” to the read/write control circuit 589, the address comparator AC1 and the tag register TG1 as the byte address “PAD1[26:2]” in order that the initial position of drawing is in the cache block RG0.

On the other hand, when the index field “PLOC[4:3]” of the pixel address “PLOC[29:0]” currently output from the plot location counter 55 designates the cache block RG1, i.e., when the index field “PLOC[4]” is “1”, the address calculator 583 outputs the current tag field “PLOC[29:5]” to the read/write control circuit 589, the address comparator AC1 and the tag register TG1 as the byte address “PAD1[26:2]”, and outputs the tag field “PLOC[29:5]” plus 1 to the read/write control circuit 589, the address comparator AC0 and the tag register TG0 as the byte address “PAD0[26:2]” in order that the initial position of drawing is in the cache block RG1.

The valid bit control circuit 584 controls the valid bit “VLD0” indicative of whether the data in the cache block RG0 is valid or invalid and the valid bit “VLD1” indicative of whether the data in the cache block RG1 is valid or invalid. Also, the valid bit control circuit 584 controls the update of the tag registers TG0 and TG1. This point will be explained in detail with respect to a truth table.

FIG. 8A is a view showing the truth table of the valid bit control signals “VCON0” and “IVCN0” output from the valid bit control circuit 584 shown in FIG. 6, and FIG. 8B is a view showing the truth table of the valid bit control signals “VCON1” and “IVCN1” output from the valid bit control circuit 584 shown in FIG. 6.

As shown in FIG. 8A, in the case where the cache flush bit “CHFL” is “false”, where the read request signal “RRQ0” is “true”, where the LSB of the plot address “PADR” is “1” and where the internal read acknowledge signal “IRGA” is “true”, or in the case where the cache flush bit “CHFL” is “false”, the read request signal “RRQ0” is “true” and where the external read acknowledge signal “ERGU” is “true”, then the valid bit control circuit 584 sets the valid bit control signal “VCON0” to “true”.

On the other hand, if the cache flush bit “CHFL” is “true”, the valid bit control circuit 584 sets the valid bit control signal “IVCN0” to “true”.

In this case, while the write operation is performed from the lower byte of the cache block RG0, it is determined separately for each block of the cache 590 whether the data in the cache 590 is valid or invalid. For this reason, one of the conditions of setting the valid bit control signal “VCON0” to “true” is that the plot address “PADR[0]” is “1”.

On the other hand, if the external read acknowledge signal “ERGU” for permitting the use of the upper byte of the second bus 33 becomes “true” when the read request signal “RRQ0” is “true”, the write operation to the cache block RG0 is completed and therefore the box of the plot address “PADR[0]” is “X” in the truth table.

Likewise, the valid bit control circuit 584 controls the valid bit control signals “VCON1” and “IVCN1” in accordance with the truth table shown in FIG. 8B. In this case, if the read request signal “RRQ0” is “false” when either the internal read acknowledge signal “IRGA” or the external read acknowledge signal “ERGU” is “true”, the read request signal “RRQ1” must be “true”.

The valid bit register VR0 saves the valid bit “VLD0”. When the valid bit control signal “VCON0” is “true”, the value of this valid bit register VR0 is set to “true” (indicating that the data of the cache block RG0 is valid) on the subsequent falling edge of the internal clock signal “ICLK”, whereas when the valid bit control signal “IVCN0” is “true”, the value of this valid bit register VR0 is set to “false” (indicating that the data of the cache block RG0 is invalid) on the subsequent falling edge of the internal clock signal “ICLK”.

Likewise, when the valid bit control signal “VCON1” is “true”, the valid bit “VLD1” stored in the valid bit register VR1 is set to “true” (indicating that the data of the cache block RG1 is valid) on the subsequent falling edge of the internal clock signal “ICLK”, whereas when the valid bit control signal “IVCN1” is “true”, the value of this valid bit register VR1 is set to “false” (indicating that the data of the cache block RG1 is invalid) on the subsequent falling edge of the internal clock signal “ICLK”.

Returning to FIG. 6, the tag register TG0 saves the tag address “TGAD0”. On the subsequent falling edge of the internal clock signal “ICLK”, the value of the tag register “TG0” is written to the byte address “PAD0” which is currently input if the valid bit control signal “VCON0” is “true”. The tag address “TGA0” is output to the address comparator AC0 and the read/write control circuit 589.

The tag register TG1 saves the tag address “TGAD1”. On the subsequent falling edge of the internal clock signal “ICLK”, the value of the tag register “TG1” is written to the byte address “PAD1” which is currently input if the valid bit control signal “VCON1” is “true”. The tag address “TGA1” is output to the address comparator AC1 and the read/write control circuit 589.

The address comparator AC0 compares the byte address “PAD0” with the tag address “TGAD0” to judges whether or not they match, and if they match the hit control signal “HCON0” is set to “true”. In other words, if they match, it means that the byte address of the memory block which is currently mapped to the cache block RG0 matches the byte address “PLOC[29:5]” included in the pixel address “PLOC” currently output from the plot location counter 55.

In like manner, the address comparator AC1 compares the byte address “PAD1” with the tag address “TGAD1”, and judges whether or not they match, and if they match the hit control signal “HCON1” is set to “true”.

When the hit control signal “HCON0” and the valid bit “VLD0” become “true” at the same time, the AND gate AN0 sets the hit signal “HT0” to “true” (the operation of drawing (writing) to or reading from the memory MEM is hit to the cache block RG0). In the same manner, when the hit control signal “HCON1” and the valid bit “VLD1” become “true” at the same time, the AND gate AN1 sets the hit signal “HT1” to “true” (the operation of drawing (writing) to or reading from the memory MEM is hit to the cache block RG1).

When pixel data is written to the position which is pointed to by the pixel address “PLOC” currently output from the plot location counter 55, the pixel packer 560 updates data in the cache 590 and outputs the updated data as the pixel data to be written. In other words, the pixel packer 560 updates the current block data “CHDA1” and “CHDA0” stored in the cache blocks RG0 and RG1 by the use of the pixel data “PCOL” stored in the plot color register 56 in accordance with the plot bits “PBT” and the pixel address “PLOC[4:0]”, and outputs the updated data “PDA0[7:0]”, “PDA0[15:8]”, “PDA1[7:0]” and “PDA1[15:8]” respectively to the multiplexers MU0L, MU0U, MU1L and MU1U. This will be described below in detail.

The multiplexer MU0L selects one of the read internal data “RIDA[7:0]”, the read external data “REDA[7:0]”, the block data “CHDA0[7:0]” and the updated data “PDA0[7:0]” in accordance with the select signal “MSL0L” output from the multiplexer control circuit 585, and outputs the selected data to the lower 8 bits of the cache block RG0. The multiplexer MU0U selects one of the read internal data “RIDA[7:0]”, the read external data “REDA[15:8]”, the block data “CHDA0[15:8]” and the updated data “PDA0[15:8]” in accordance with the select signal “MSL0U ” output from the multiplexer control circuit 585, and outputs the selected data to the upper 8 bits of the cache block RG0.

The multiplexer MU1L selects one of the read internal data “RIDA[7:0]”, the read external data “REDA[7:0]”, the block data “CHDA1[7:0]” and the updated data “PDA1[7:0]” in accordance with the select signal “MSL1L” output from the multiplexer control circuit 585, and outputs the selected data to the lower 8 bits of the cache block RG1. The multiplexer MU1U selects one of the read internal data “RIDA[7:0]”, the read external data “REDA[15:8]”, the block data “CHDA1[15:8]” and the updated data “PDA1[15:8]” in accordance with the select signal “MSL1U” output from the multiplexer control circuit 585, and outputs the selected data to the upper 8 bits of the cache block RG1.

The multiplexer control circuit 585 serves to generate the select signals “MSL0L”, “MSL0U ”, “MSL1L” and “MSL1U” for controlling the multiplexers MU0L, MU0U, MU1L and MU1U respectively on the basis of the plot active bit “PACT”, the cache hit signal “CHHT”, the read request signal “RRQ0”, the plot address “PADR[0]”, the internal read acknowledge signal “IRGR”, the external upper byte read acknowledge signal “ERGU” and the external lower byte read acknowledge signal “ERGL”. More detailed explanation will be given with reference to a truth table.

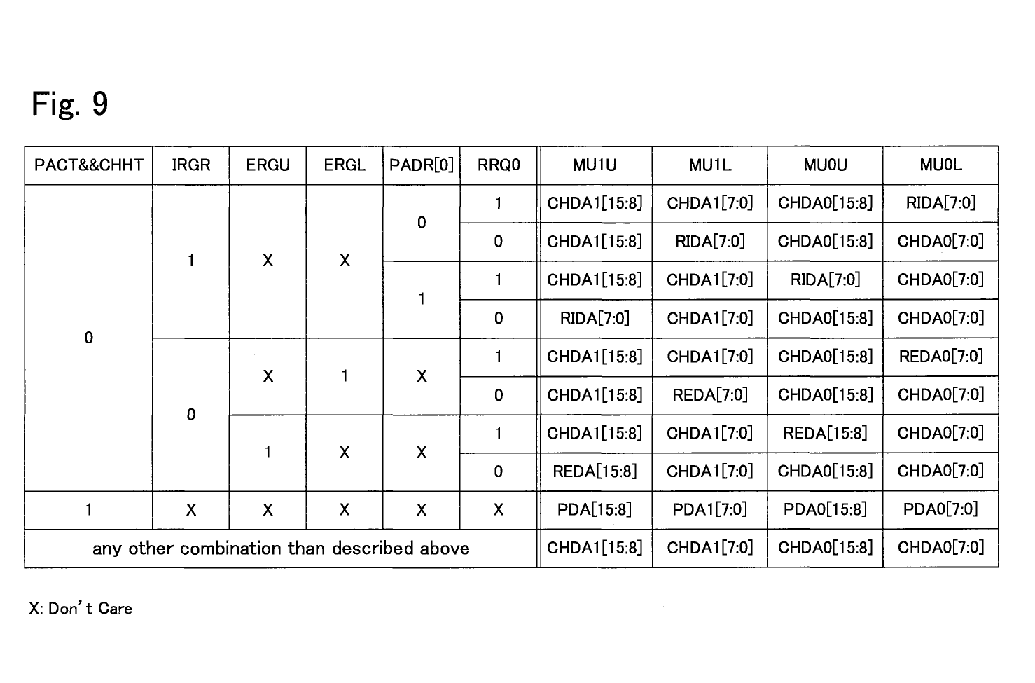

FIG. 9 is a truth table showing the selection of data by the multiplexers MU0L, MU0U, MU1L and MU1U in response to the select signals “MSL1U”, “MSL1L”, “MSL0U ” and “MSL0L” generated by the multiplexer control circuit 585 of FIG. 6. As shown in FIG. 9, if the read request signal “RRQ0” is “true”, if the LSB of the plot address “PADR” is “0”, and if the internal read acknowledge signal “IRGR” is “true”, then the multiplexer control circuit 585 generates the select signal “MSL0L” for selecting the read internal data “RIDA[7:0]”. Also, in this case, the multiplexer control circuit 585 generates the select signals “MSL0U ”, “MSL1L” and “MSL1U” for selecting the block data “CHDA0[15:8]”, the block data “CHDA1[7:0]” and the block data “CHDA1[15:8]” respectively.

In the same manner, the multiplexer control circuit 585 generates the select signal “MSL0U ”, “MSL1L” or “MSL1U” for selecting the read internal data “RIDA[7:0]”, generates the select signal “MSL0L” or “MSL1L” for selecting the read external data “REDA[7:0]”, and generates the select signal “MSL0U” or “MSL1U” for selecting the read external data “REDA[15:8]”, when the corresponding combination of the input signals shown in the truth table of FIG. 9 occurs.

On the other hand, if the plot active bit “PACT” is “true” and if the cache hit signal “CHHT” is “true”, the multiplexer control circuit 585 generates the select signals “MSL0L”, “MSL0U”, “MSL1L” and “MSL1U” for selecting the updated data “PDA0[7:0]”, “PDA0[15:8]”, “PDA1[7:0]” and “PDA1[15:8]” respectively.

If the input signals are input in any other combination than described above, the multiplexer control circuit 585 generates the select signals “MSL0L”, “MSL0U”, “MSL1L” and “MSL1U” for selecting the block data “CHDA0[7:0]”, “CHDA0[15:8]”, “CHDA1[7:0]” and “CHDA1[15:8]”. In this case, the contents of the cache blocks RG0 and RG1 remain as they are.

Returning to FIG. 6, when reading the pixel data that is pointed to by the pixel address “PLOC” currently output from the plot location counter 55, the pixel unpacker 586 extracts the pixel data from the cache blocks RG0 and RG1 and outputs a pixel data item consisting only of a single pixel. In other words, in accordance with the plot bits “PBT” and the pixel address “PLOC[4:0]”, the pixel unpacker 586 divides the block data “CHDA0” currently stored in the cache block RG0 and the block data “CHDA1” currently stored in the cache block RG1 into data units of individual pixels, and outputs them on a pixel-by-pixel basis. This will be described below in detail.

When the plot active bit “PACT” is “true”, the read/write control circuit 589 generates the write request signal “WREQ”, the write address “WADR”, the read request signal “RREQ”, the read address “RADR”, the cache hit signal “CHHT”, the read request signal “RRQ0”, the write request signal “WRQ0” and/or the write request signal “WRQ1” at appropriate timings. This will be described below in detail.

When the write request signal “WRQ0” or the write request signal “WRQ1” becomes “true”, the read/write control circuit 589 asserts the write request signal “WREQ”.

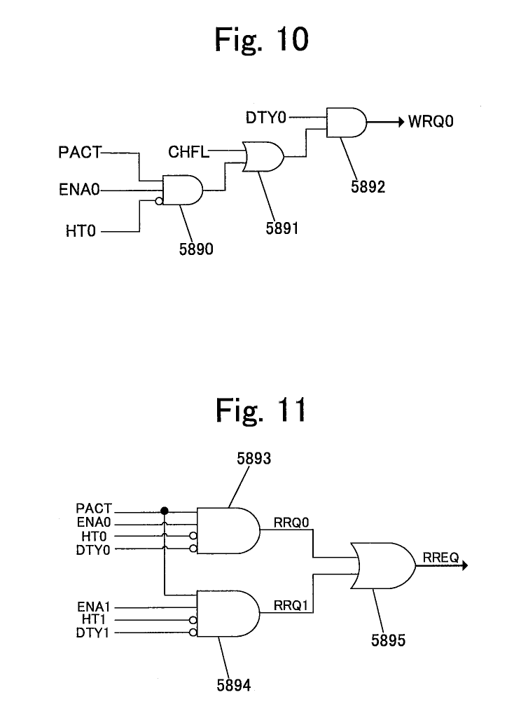

FIG. 10 is a circuit diagram showing a circuit for generating the write request signal “WRQ0” of FIG. 6. This circuit is implemented within the read/write control circuit 589 and comprises an AND gate 5890, an OR gate 5891 and an AND gate 5892.

The AND gate 5890 receives at its inputs the plot active bit “PACT”, the enable bit “ENA0” and the inversion signal of the hit signal “HT0”. The OR gate 5891 receives at its inputs the output signal of the AND gate 5890 and the cache flush bit “CHFL”. The AND gate 5892 receives at its inputs the dirty bit “DTY0” and the output signal of the OR gate 5891.

As is apparent from the figure, if the cache flush bit “CHFL” is “true” and if the dirty bit “DTY0” is “true”, then the write request signal “WRQ0” is asserted. Alternatively, if the plot active bit “PACT” is “true”, if the enable bit “ENA0” is “true”, if the hit signal “HT0” is “false” and if the dirty bit “DTY0” is “true”, then the write request signal “WRQ0” is asserted.

Incidentally, the circuit for generating the write request signal “WRQ1” is implemented within the read/write control circuit 589 and designed in the same manner as in FIG. 10.

FIG. 11 is a circuit diagram showing a circuit for generating the read request signal “RREQ” of FIG. 6. This circuit is implemented within the read/write control circuit 589, and comprises AND gates 5893 and 5894 and an OR gate 5895.

The AND gate 5893 receives at its inputs the plot active bit “PACT”, the enable bit “ENA0”, the inversion signal of the hit signal “HT0” and the inversion signal of the dirty bit “DTY0”. Then, if the plot active bit “PACT” is “true”, if the enable bit “ENA0” is “true”, if the hit signal “HT0” is “false” and if the dirty bit “DTY0” is “false”, then the AND gate 5893 sets the read request signal “RRQ0” to “true”.

In this case, the condition that the dirty bit “DTY0” is “false” is provided because necessary data has to be read only after a write back operation to the memory MEM is completed to maintain coherency. Meanwhile, if the dirty bit “DTY0” is “true”, it means that coherency is not maintained so that a write back operation is necessary in advance of a read operation.

The AND gate 5894 receives at its inputs the plot active bit “PACT”, the enable bit “ENA1”, the hit signal “HT1” and the dirty bit “DTY1”. Then, if the plot active bit “PACT” is “true”, if the enable bit “ENA1” is “true”, if the hit signal “HT1” is “false” and if the dirty bit “DTY1” is “false”, then the AND gate 5894 sets the read request signal “RRQ1” to “true”.

If the read request signal “RRQ0” or “RRQ1” is “true”, then the OR gate 5895 sets the read request signal “RREQ” to “true”.

Returning to FIG. 6, in the case where only the enable bit “ENA0” is “true”, the read/write control circuit 589 asserts the cache hit signal “CHHT” if the hit signal “HT0” of the cache block RG0 is “true”; in the case where only the enable bit “ENA1” is “true”, the read/write control circuit 589 asserts the cache hit signal “CHHT” if the hit signal “HT1” of the cache block RG1 is “true”; and in the case where both the enable bit “ENA0” and the enable bit “ENA1” are “true”, the read/write control circuit 589 asserts the cache hit signal “CHHT” if both the hit signal “HT0” of the cache block RG0 and the hit signal “HT1” of the cache block RG1 are “true”. Otherwise, the read/write control circuit 589 negates the cache hit signal “CHHT”.

When the read request signal “RREQ” is asserted, the read/write control circuit 589 generates the read address “RADR[26:0]”. More specific description is as follows.

If the read request signal “RRQ0” is “true”, the read/write control circuit 589 sets the byte address “PADR[0]” to the read address “RADR[0]”, the read address “RADR[1]” to “0”, and the byte address “PAD0[26:2]” to the read address “RADR[26:2]”.

On the other hand, if the read request signal “RRQ1” is “true”, the read/write control circuit 589 sets the byte address “PADR[0]” to the read address “RADR[0]”, the read address “RADR[1]” to “1”, and the byte address “PAD1[26:2]” to the read address “RADR[26:2]”.

However, if both the read request signals “RRQ0” and “RRQ1” are “true”, the read/write control circuit 589 places priority on the read request signal “RRQ0” such that the read address “RADR[26:0]” is generated on the basis of the read request signal “RRQ0” and thereafter the read address “RADR[26:0]” is generated on the basis of the read request signal “RRQ1”.

When the write request signal “WREQ” is asserted, the read/write control circuit 589 generates the write address “WADR[26:0]”. More specific description is as follows.

When writing data to the main memory 17, the read/write control circuit 589 sets the write address “WADR[0]” to “0” and “1” one after the other. On the other hand, when writing data to the external memory 45, the write address “WADR[0]” is set to “0” because the write data “WDA” is output to the second bus arbiter 14 as 2-byte data. Thereafter, the address control is performed by the second bus arbiter 14.

If the write request signal “WRQ0” is “true”, the read/write control circuit 589 sets the write address “WADR[1]” to “0” and the tag address “TGAD0[26:2]” to the write address “WADR[26:2]”.

On the other hand, if the write request signal “WRQ1” is “true”, the read/write control circuit 589 sets the write address “WADR[1]” to “1” and the tag address “TGAD1[26:2]” to the write address “WADR[26:2]”.

However, if both the write request signals “WRQ0” and “WRQ1” are “true”, the read/write control circuit 589 places priority on the write request signal “WRQ0” such that the write address “WADR[26:0]” is generated on the basis of the write request signal “WRQ0” and thereafter the write address “WADR[26:0]” is generated on the basis of the write request signal “WRQ1”.

In this case, the read address “RADR” is generated by the use of the byte address “PAD0” or PAD1. This is because, when the read request signal “RREQ” is asserted, data to be written to the cache block RG0 or RG1 must be read from the memory MEM.

On the other hand, the write address “WADR” is generated by the use of the tag address “TGAD1”. This is because, when the write request signal “WREQ” is asserted, the data stored currently in the cache block RG0 or RG1 must be written to the memory MEM in order to maintain coherency.

When the write request signal “WRQ0” is asserted, the read/write control circuit 589 outputs the data “CHDA0[15:0]” stored in the cache block RG0 as the write data “WDA0[15:0]”. Also, when the write request signal “WRQ1” is asserted, the read/write control circuit 589 outputs the data “CHDA1[15:0]” stored in the cache block RG1 as the write data “WDA[15:0]”.

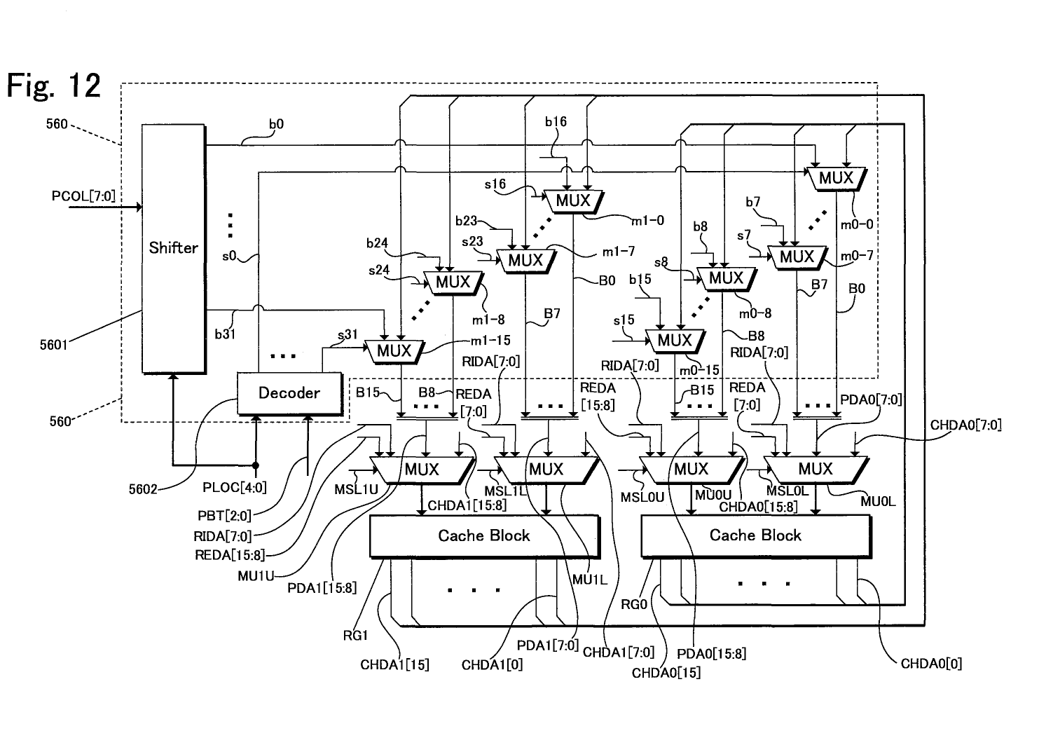

FIG. 12 is a circuit diagram of the pixel packer 560 of FIG. 6. As shown in FIG. 12, this pixel packer 560 includes a shifter 5601, a decoder 5602, multiplexers m0-3 to m0-m15 and multiplexers m1-m0 to m1-m15. The shifter 5601 is a cyclic shifter which returns upper bits, as shifted out, to lower bits.

The bit signals “b0” to “b15” output from the shifter 5601 are given to the multiplexers m0-0 to m0-15 respectively through one input terminal of each multiplexer, and the bit signals “b16” to “b31” output from the shifter 5601 are given to the multiplexers m1-0 to m1-15 respectively through one input terminal of each multiplexer.

The multiplexers m0-0 to m0-15 receive respectively the bits “CHDA0[0]” to “CHDA0[15]” of the cache block RG0 at the other terminals thereof, and the multiplexers m1-0 to m1-15 receive respectively the bits “CHDA1[0]” to “CHDA1[15]” of the cache block RG1 at the other terminals thereof.

The output signals “B0” to “B7” of the multiplexers m0-0 to m0-7 are given respectively to the input terminals of the multiplexer MU0L. The output signals “B8” to “B15” of the multiplexers m0-8 to m0-15 are given respectively to the input terminals of the multiplexer MU0U. The output signals “B0” to “B7” of the multiplexers m1-0 to m1-7 are given respectively to the input terminals of the multiplexer MU1L. The output signals “B8” to “B15” of the multiplexers m1-8 to m1-15 are given respectively to the input terminals of the multiplexer MU1U.

The decoder 5602 assumes that 32-bit contiguous data is stored in the cache blocks RG0 and RG1, decodes the pixel address “PLOC[4:0]”, and obtains the bit position, in the 32 bits, of the first bit of the pixel data included in the drawing target data “PCOL” (i.e., the first bit of the pixel data to be drawn). Furthermore, the decoder 5602 obtains the bit position, in the 32 bits, of the last bit of the pixel data to be drawn on the basis of the bit position of the first bit of the pixel data to be drawn and the plot bits “PBT[2:0]”.

The decoder 5602 controls select signals “s0” to “s31” on the basis of the above results. The select signals “s0” to “s31” are given respectively to the corresponding multiplexers m0-0 to m1-15 in order to select one of the two input terminals of each of the multiplexers m0-0 to m1-15.

In this description, the term “multiplexer m”, the term “bit signal b”, the term “bit signal “CHDA” and the term “select signal s” are used respectively to generally represent the multiplexers m0-0 to m1-15, the bit signals “b0” to “b31”, the bit signals “CHDA0[0]” to “CHDA1[15]” and the select signals “s0” to “s31”.

More specifically speaking, the decoder 5602 outputs the select signals “s” for selecting the bit signals “b” of the shifter 5601 to the multiplexers m corresponding to the bit positions from the first bit to the last bit of the pixel data to be drawn, and outputs the select signals “s” for selecting the bit signals “CHDA” of the cache blocks RG0 and/or RG1 to the remaining multiplexers m.

On the other hand, the shifter 5601 shifts the drawing target data “PCOL” to be drawn by a necessary number of bits and outputs the shifted data as the bit signals “b0” to “b31” respectively to the corresponding multiplexers m0-0 to m1-15 in order to align the first bit of the pixel data included in the drawing target data “PCOL” (i.e., the first bit of the pixel data to be drawn) with the bit position pointed to by the pixel address “PLOC[4:0]”.

Each of the multiplexers m0-0 to m1-15 selects one of its two input signals in accordance with the corresponding one of the select signals “s0” to “s31”, and outputs the selected signal to the corresponding one of the multiplexers MU0L, MU0U, MU1L and MU1U. As a result, the data “CHDA0[0]” to “CHDA1[15]” stored in the cache blocks RG0 and RG1 are updated by the pixel data to be drawn, and the updated data “PDA0[0]” to “PDA1[15]” are given to the multiplexers MU0L, MU0U, MU1L and MU1U.

This will be explained with reference to a specific example. For example, it is assumed that the bit position pointed to by the pixel address “PLOC[4:0]” from which drawing is started is the 16th bit of the cache block RG0 and that the color mode indicated by the plot bits “PBT[2:0]” is 3 bits per pixel. Accordingly, in this case, the bit position of the last bit of the pixel data to be drawn is the second bit of the cache block RG1.

As a result, the multiplexers m0-0 to m0-14 selects and outputs the bit signals “CHDA0[0]” to “CHDA0[14]”; the multiplexers m0-15, m1-0 and m1-1 selects and outputs the bit signals “b15”, “b16” and “b17”; and the multiplexers m1-2 to m1-15 selects and outputs the bit signals “CHDA1[2]” to “CHDA1[15]”.

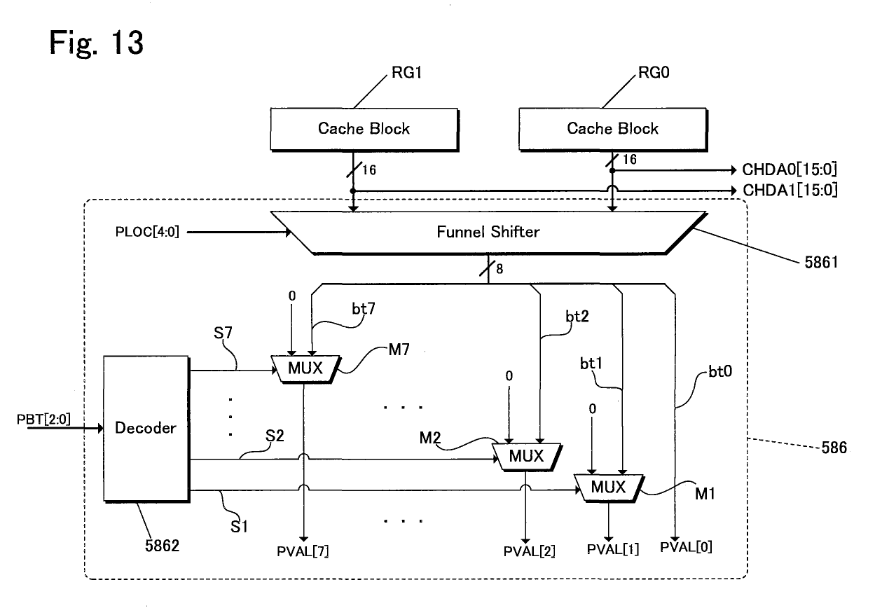

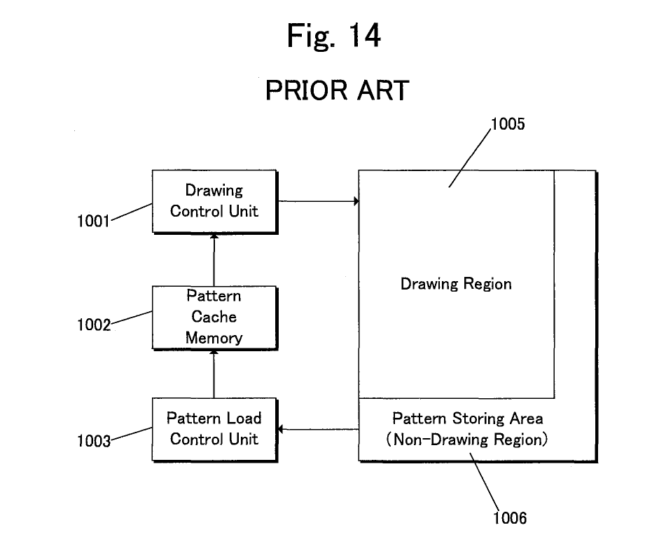

FIG. 13 is a circuit diagram of the pixel unpacker 586 of FIG. 6. As shown in FIG. 13, the pixel unpacker 586 includes a funnel shifter 5861, a decoder 5862 and multiplexers M1 to M7.

The funnel shifter 5861 receives the block data “CHDA0[15:0]” stored in the cache block RG0 and the block data “CHDA1[15:0]” stored in the cache block RG1. Then, the funnel shifter 5861 selects 8 bits “bt0” to “bt7” from among the block data “CHDA0[15:0]” and “CHDA1[15:0]” as input in accordance with the pixel address PLOC[4:0]. In this case, the funnel shifter 5861 outputs the bits “bt1” to “bt7” of the selected 8 bits “bt0” to “bt7” to the multiplexers M1 to M7 respectively through one input terminal of each multiplexer.

More specifically speaking, the funnel shifter 5861 assumes that 32-bit contiguous data is stored in the cache blocks RG0 and RG1, obtains the bit position, in the 32 bits, of the first bit of the pixel data to be read on the basis of the pixel address “PLOC[4:0]”, and outputs 8 bits “bt0” to “bt7” starting from the bit position.

The other input terminals of the respective multiplexers M1 to M7 are given a signal indicative of “0”. Each of the multiplexers M1 to M7 selects one of the two input signals in accordance with the corresponding one of the select signals “S1” to “S7”, and outputs the selected signal as the corresponding part of the drawing cached data “PVAL[1]” to “PVAL[7]”. The bit “bt0” output from the funnel shifter 5861 is simply output as the drawing cached data “PVAL[0]”. This is because, while the plot bits “PBT[2:0]” necessarily designates a color mode, at least one bit is contained as the pixel data in the 8 bits output from the funnel shifter 5861.

In this description, the term “multiplexer M”, the term “select signal S” and the term “bit signal bt” are used respectively to generally represent the multiplexers M1 to M7, the select signals “S1” to “S7” and the bit signals “bt1” to “bt7”.

The decoder 5862 decodes the plot bits “PBT[2:0]”, obtains the bit position of the last bit of the pixel data to be read, and generate the select signal “S” in accordance with the bit position. In other words, the decoder 5862 outputs the select signals “S” for selecting “0” to the multiplexers M corresponding to upper bit positions than the bit position of the last bit of the pixel data to be read, and outputs the select signals “S” for selecting the bit “bt” to the remaining multiplexers M.

For example, in the case where the color mode indicated by the plot bits “PBT[2:0]” is 3 bits per pixel, the decoder 5862 outputs the select signals “S1” and “S2” for selecting the bit signals “bt1” and “bt2” respectively to the multiplexers M1 and M2, and outputs the select signals “S3” to “S7” for selecting “0” respectively to the multiplexers M3 to M7.

As has been discussed above, the drawing cached data “PVAL[7:0]” including single pixel data is output. That is, the CPU 1 can read data from the cache 590 separately for each individual pixel.

By the way, in accordance with the present embodiment as has been discussed above, it is possible to set a color mode (M bits/pixel) without awareness of the number “N” of bits forming one word of the memory which is currently used. Generally speaking, when the configuration of bitmap images is determined, the number “M” of bits representing a color mode is selected in order that N/M is an integer, i.e., any one pixel is stored in order not to span two words of the memory, or that M/N is an integer, i.e., the data of one pixel is stored and just fitted in one or more word areas of the memory, such that the range of choice of the color mode is narrow. However, the application of the present invention is not limited to the drawing of bitmap images.

The pixel plotter 5 can write pixel data prepared by the CPU 1 to the cache 590. In this case, the drawing by the pixel plotter 5 is not performed by directly accessing the memory MEM and acquiring the pixel data. Since the pixel data is prepared by the CPU 1, the pattern data to be drawn may be predetermined pattern data prepared in advance, pattern data as compressed, pattern data as input by a user through an input device (such as a tablet). In addition, since the cache 590 is used, it is possible to perform high speed drawing. As a result, it is possible to quickly draw arbitrary patterns in individual pixels.

Furthermore, since the pixel plotter 5 can autonomously operate as a bus master, the CPU 1 can process another task while the pixel plotter 5 is performing the drawing. Accordingly, an effective process can be realized when viewed as the whole of the processor 100. Also, since the drawing process can be performed by the pixel plotter 5 serving as a bus master, it is possible to lessen the burden of writing a program to be run in the CPU 1.

Generally, when a CPU performs drawing on a memory, the drawing is performed in bytes or words as units which can be handled by the CPU, and therefore if the drawing is performed in bits, the CPU has to perform read-modify-write operations which substantially burden the CPU, and the programming becomes complicated. Contrary to this, in accordance with the present invention, the pixel plotter 5 functions as the bus master and can be responsible for performing read-modify-write operations while the CPU 1 can perform another task, and the burden of programming can be lessened without awareness of read-modify-write operations.

Furthermore, the pixel plotter 5 is designed as a bus master which can share the memory MEM with the CPU 1 and other bus masters, and therefore a dedicated memory and a bus for drawing need not be prepared such that the cost can be reduced. Namely, if the pixel plotter 5 were not a bus master, it could not autonomously access the bus (the first bus 31 or the second bus 33) and thereby a dedicated memory and a bus for drawing must be prepared to incur an additional cost, which is not needed in the case of the present invention.

Furthermore, the pixel address “PLOC[29:0]” pointing to the drawing position consists of the byte address “PLOC[29:3]” which is an address in bytes pointing to the byte location including the first bit of the pixel data to be drawn, and the bit address “PLOC[2:0]” which is an address pointing to the bit position within the byte of the first bit of the pixel data to be drawn. In like manner, the pixel address “PLOC[29:0]” pointing to the reading position consists of the byte address “PLOC[29:3]” which is an address in bytes pointing to the byte location including the first bit of the pixel data to be read, and the bit address “PLOC[2:0]” which is an address pointing to the bit position within the byte of the first bit of the pixel data to be read.

As thus described, the CPU 1 informs the pixel plotter 5 of a drawing or reading position designated by not only a byte address but also a bit address, and therefore the CPU 1 can be free from the burden of calculating the bit position within a byte from which a drawing or reading operation is performed in individual pixels so that fast operations and simplification of programming can be realized. In usual, an address as used is a byte address, and therefore if the number of bits of one pixel is smaller than the number of bits of one word of the memory, the calculation of the bit position within a byte must be performed when the drawing is performed in individual pixels.

Furthermore, the cache 590 consists of two cache blocks RG0 and RG1 to which two memory blocks of the memory MEM are mapped. By the use of such a minimum necessary construction, drawing and reading operations can be effectively performed across a word boundary of the memory MEM.

Furthermore, the cache blocks RG0 and RG1 are composed respectively of registers. Accordingly, as compared with the case where the cache 590 were composed of RAM cells, faster drawing and reading operations become possible. Also, in the case where the number of total bits forming the cache is comparatively small, the area occupied by a cache comprising registers in a semiconductor chip may be smaller than that occupied by a cache comprising RAM cells.

Furthermore, the way of mapping two memory blocks of the memory MEM to the cache 590 is direct mapping. In accordance with the present embodiment, while making effective use of the advantage of the direct mapping technique that the circuit design is simplified, the disadvantage of the direct mapping technique that the cache hit ratio decreases when successively accessing a plurality of memory blocks mapped to the same cache block resulting in cache collision is not an issue because the drawing operation is usually performed in contiguous addresses.

Furthermore, data coherency between the memory MEM and the cache 590 is maintained by write back operations. In accordance with the present embodiment, while making effective use of the advantage of the write back operations that the memory access is restrained, the disadvantage of the write back operations that data coherency is not always maintained can be resolved by a cache flush operation which is performed by the CPU 1 in order to forcibly write back data from the cache 590 to the memory MEM.

Furthermore, while a drawing or reading operation is performed by the CPU 1 on a pixel-by-pixel basis, the read/write control circuit 589 outputs the write data “WDA” on a byte-by-byte basis or a word-by-word basis of the memory MEM. Accordingly, it is possible to restrain the frequency of accessing the bus as compared with the case of outputting the write data on a pixel-by-pixel basis.

In like manner, the operation of reading data from the memory MEM is performed on a byte-by-byte basis or a word-by-word basis of the memory MEM when the read address is outside of the current caching range. Accordingly, it is possible to restrain the frequency of accessing the bus as compared with the case of reading data on a pixel-by-pixel basis.

Furthermore, since the plot location counter 55 automatically updates the drawing or reading address, it is possible to quickly perform the drawing or reading of a sequence of pixel data. In other words, the CPU 1 need not generate an address for supplying the address to the pixel plotter 5 every time the drawing is performed.

Incidentally, the present invention is not limited to the above embodiments, and a variety of variations and modifications may be effected without departing from the spirit and scope thereof, as described in the following exemplary modifications.

In accordance with the embodiment as has been discussed above, the way of mapping two memory blocks of the memory MEM to the cache 590 is direct mapping. However, alternatively, the way of mapping two memory blocks of the memory MEM to the cache 590 can be fully associative mapping, which has a better hit ratio. In this case, the tag registers TG0 and TG1 are made respectively of 26-bit registers and capable of storing 26-bit tag addresses “TGAD0[26:1]” and “TGAD1[26:1]” respectively for pointing to an arbitrary address.

Furthermore, it is possible to use the cache 590 as a one-line cache memory by designing the cache system in order that the cache blocks RG0 and RG1 always store 32-bit contiguous data of the memory MEM as a single 32-bit register. In this case, it is possible to dispense with one of each pair of elements, which are provided respectively for the two cache blocks RG0 and RG1 in the case of the above embodiment, such as the tag registers TG0 and TG1, the valid bit registers VR0 and VR1, the address comparators AC0 and AC1 and several pairs of the control signals. This configuration is effective for the purpose of reducing the amount of hardware in the case where the processing as required of the application is relatively simple.

Still further, the way of mapping two memory blocks of the memory MEM to the cache 590 can be set associative mapping. In this case, in addition to the two cache blocks and the tag registers of the above embodiment, one more set of the two cache blocks and the tag registers are provided such that if a cache hit occurs the above control is performed for the hit cache block. It is easy as a routine work for those skilled in the art to design an embodiment of the present invention in combination with such a set associative cache, in place of the direct mapped cache 590, on the basis of the above disclosure.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

1. A data processing unit operable to perform a write operation of pixel data which designates a display color of one pixel by M bits (M is 1 or a larger integer), comprising:
a memory operable to provide a drawing area;
an arithmetic processing unit operable to perform arithmetic operations in accordance with a program; and
a drawing unit operable to perform the write operation of the pixel data given from said arithmetic processing unit on a pixel-by-pixel basis in accordance with address information pointing to a drawing position generated by said arithmetic processing unit,
wherein said drawing unit comprising:
a cache to which a block of said memory is dynamically mapped and to which the same logical address is assigned as the block; and
a cache control unit operable to write the pixel data to said cache on a pixel-by-pixel basis regardless of whether or not each of N/M and M/N is an integer where N is the number of bits per word of said memory (N is 2 or larger integer).

2. The data processing unit as claimed in claim 1 further comprising a bus,
wherein said memory, said arithmetic processing unit and said drawing unit are connected to said bus, and
wherein said arithmetic processing unit and said drawing unit function respectively as a bus master of said bus.

3. A data processing unit operable to perform a write operation of pixel data which designates a display color of one pixel by M bits (M is 1 or a larger integer), comprising:
a memory operable to provide a drawing area;
an arithmetic processing unit operable to perform arithmetic operations in accordance with a program and generate address information pointing to a drawing position; and
a drawing unit operable to perform the write operation of the pixel data given from said arithmetic processing unit on a pixel-by-pixel basis,
wherein said drawing unit comprising:
a cache to which a block of said memory is dynamically mapped and to which the same logical address is assigned as the block; and
a cache control unit operable to write the pixel data to said cache on a pixel-by-pixel basis in accordance with the address information generated by said arithmetic processing unit,
wherein the address information pointing to a drawing position contains a byte address pointing to a byte in which the first drawing bit of pixel data to be drawn is located and a bit address pointing to a bit position of the first drawing bit within the byte.

4. A drawing device comprising:
a cache to which a block of a memory providing a drawing area is dynamically mapped and to which the same logical address is assigned as the block; and
a cache control unit operable to write pixel data to be drawn which designates a display color of one pixel by M bits (M is 1 or a larger integer) to said cache on a pixel-by-pixel basis in accordance with address information pointing to a drawing position regardless of whether or not each of N/M and M/N is an integer where N is the number of bits per word of the memory (N is 2 or larger integer).

5. The drawing device as claimed in claim 4 wherein the address information pointing to a drawing position contains a byte address pointing to a byte in which the first drawing bit of the pixel data to be drawn is located and a bit address pointing to a bit position of the first drawing bit within the byte, and
wherein said cache control unit judges whether cache hit or miss occurs on the basis of the byte address and, if cache hit occurs, updates block data as read from said cache by the pixel data to be drawn on the basis of the byte address, the bit address and the number M of bits of the pixel data, and writes the updated block data to said cache.

6. The drawing device as claimed in claim 5 wherein said cache comprises a plurality of blocks to which a plurality of blocks of the memory are mapped dynamically and respectively and to which the same logical addresses are assigned as the blocks of the memory respectively,
wherein, when updating the block data, said cache control unit updates M bits, which start from the drawing position pointed to by the bit address, of the block data stored in said block designated by the byte address by the use of the pixel data to be drawn, wherein if the pixel data to be drawn is stored to span two blocks, said cache control unit updates M bits by the use of the pixel data to be drawn, which start from the drawing position, with regards to the block data stored in said block designated by the byte address and the block data stored in said block designated by the byte address which is the byte address as incremented by one.

7. The drawing device as claimed in claim 5 wherein said cache control unit judges whether cache hit or miss occurs on the basis of a byte address (referred to hereinbelow as the read byte address) pointing to a byte in which the first reading bit of pixel data to be read is located and, if cache hit occurs, extracts the pixel data from the block data as read from said cache on the basis of the read byte address, a bit address (referred to hereinbelow as the read bit address) pointing to the bit position of the first reading bit within the byte and the number M of bits of the pixel data.

8. The drawing device as claimed in claim 7 wherein said cache comprises a plurality of blocks to which a plurality of blocks of the memory are mapped dynamically and respectively and to which the same logical addresses are assigned as the blocks of the memory respectively,
wherein, when extracting the pixel data to be read, said cache control unit extracts M bits of the pixel data to be read which start from the first reading bit, wherein if the pixel data to be read is stored to span two blocks, said cache control unit extracts M bits of the pixel data to be read, which start from the first reading bit, from the block data stored in said block designated by the read byte address and the block data stored in said block designated by the byte address which is the read byte address as incremented by one.

9. The drawing device as claimed in claim 6 wherein said cache includes two blocks to which two blocks of the memory are mapped.

10. The drawing device as claimed in claim 4 wherein when write data is output in order to maintain data coherency, said cache control unit outputs the write data on a byte-by-byte basis or a word-by-word basis of the memory.

11. The drawing device as claimed in claim 4 wherein when a memory operation is performed in an address outside of the current area of caching, said cache control unit reads data stored in this address of the memory on a byte-by-byte basis or a word-by-word basis of the memory.

12. The drawing device as claimed in claim 4 further comprising a drawing and reading position calculating unit operable to calculate address information pointing to a next drawing or reading position on the basis of a current drawing or reading position.

13. The drawing device as claimed in claim 12 wherein said drawing and reading position calculating unit operable to calculate the address information pointing to the next drawing or reading position by adding the number M of bits of the pixel data to the current drawing or reading position.

14. The drawing device as claimed in claim 4 wherein said drawing device is connected to a bus to which the memory is connected, and wherein
said drawing device functions as a bus master of the bus.

15. A data processing unit comprising:
an address bus through which an address space can be accessed;
a data bus operable to transport data by designating an address of the address space through said address bus;
a central processing unit connected to said address bus and said data bus and operable to perform operations of reading and writing data through said address bus and said data bus; and
a cache system connected to said address bus and said data bus and operable to perform caching data stored in part of the address space,
wherein said cache system includes control registers to which said central processing unit writes data, and functions as a bus master of said address bus and said data bus,
wherein said central processing unit is capable of performing read and write operations through said address bus and said data bus without the use of said cache system, and writing data to said control registers of said cache system in order to instruct said cache system to perform read and write operations through said address bus and said data bus as a bus master, and
wherein said central processing unit is capable of performing another task after instructing said cache system to perform a read or write operation through said address bus and said data bus.

16. The data processing unit as claimed in claim 15 further comprising data transmission channel having a higher data transmission rate than that of said address bus and said data bus wherein writing data to said control registers of said cache system by said central processing unit is performed through the data transmission channel.

17. The data processing unit as claimed in claim 16 wherein said address bus and said data bus are provided for communication with an external memory providing a physical storage area in the address space, and wherein the data transmission channel comprises an internal bus for communication among internal bus devices including said central processing unit.

18. A drawing device operable to plot a pixel in a drawing area comprising:
a bus interface connectable to an address bus through which an address space including the drawing area can be accessed and a data bus operable to transport data by designating an address of the address space through said address bus;
a data storage unit connected to said bus interface, said bus interface serving to transfer image data to said data storage unit from said data bus and output the data stored in said data storage unit to said data bus respectively by outputting an address which points to the image data in the address space to said address bus;
a plot color register operable to store pixel data of a pixel to be plotted in the drawing area;
a color mode register operable to store a color mode as the number of bits per pixel;
a plot location counter operable to store the address pointing to the image data as a byte address and a bit position within the byte pointed to by the byte address as a bit address, wherein the byte address and the bit address point to a plot location in bits, and operable to increment the plot location after plotting the pixel data to the plot location by the number of bits corresponding to the color mode stored in said color mode register;
a pixel packer connected to said plot color register, said color mode register, said plot location counter and said data storage unit, and operable to align in bits the bit position of the pixel data stored in said plot color register relative to the image data as transferred to said data storage unit with the plot location pointed to by said plot location counter, and write the pixel data to the image data as transferred to said data storage unit at the plot location on the basis of the number of bits corresponding to the color mode stored in said color mode register.

19. The drawing device as claimed in claim 18 further comprising a pixel unpacker connected to said plot location counter and said data storage unit, and operable to receives the pixel data located in the image data transferred to said data storage unit at the plot location pointed to by said plot location counter, and output data containing this pixel data aligned at the first bit thereof.

20. The drawing device as claimed in claim 19 wherein said pixel unpacker is connected further to said color mode register, and output the data containing the pixel data zero-extended on the basis of the number of bits corresponding to the color mode stored in said color mode register.

21. A pixel packer operable to pack a plurality of pixel data items, wherein each pixel data item contains lower bits which are pixel data bits representing a pixel value and the remaining upper bits which are unused bits, said pixel packer comprising:
a storage unit operable to store data having a predetermined bit length;
a shifter having an output port of the predetermined bit length and operable to successively receive the pixel data item, shift the pixel data item in alignment with a first bit position, and output the pixel data item as shifted through the output port; and
a data transfer unit connected to said storage unit and said shifter and operable to transfer the pixel data bits as shifted from said shifter to said storage unit,
wherein the first bit position is updated after data transfer by shifting the first bit position by the length of the lower bits of the pixel data item, and wherein the pixel data bits are transferred in order not to change the storage area of said storage unit corresponding to the previous position of the first bit position where the previous pixel data bits are stored.

22. The pixel packer as claimed in claim 21 wherein the shift operation of the first bit position is a cyclic shift operation of the predetermined bit length.
